(19) United States
(12) Patent Application Publication
(10) Pub. No.: US 2024/0179730 A1
(43) Pub. Date: May 30, 2024

(54) METHOD AND APPARATUS FOR INTER-USER EQUIPMENT (UE) COORDINATION IN SIDELINK (SL) COMMUNICATIONS

(71) Applicant: Huawei Technologies Co, Ltd., Shenzhen (CN)

(72) Inventors: Guosen Yue, Edison, NJ (US); Brian Classon, St. Pete Beach, FL (US); Vipul Desai, Palatine, IL (US)

(21) Appl. No.: 18/431,540

(22) Filed: Feb. 2, 2024

Related U.S. Application Data
(63) Continuation of application No. PCT/US2022/039424, filed on Aug. 4, 2022.
(60) Provisional application No. 63/230,548, filed on Aug. 6, 2021.
(60) Provisional application No. 63/229,866, filed on Aug. 5, 2021.

(51) Int. Cl. H04W 72/40; H04W 72/25; H04W 72/54

(52) U.S. Cl. CPC H04W 72/40; H04W 72/25; H04W 72/54

(57) ABSTRACT

According to embodiments, a first UE (e.g., UE A) receives from a second UE (e.g., UE B) a sidelink control information (SCI) in a first slot. The SCI comprises a resource reservation for a shared channel. The resource reservation indicates a set of frequency resources and a time resource assignment. The first UE transmits to the second UE a conflict indicator on resources of a feedback channel. The resources of the feedback channel include a second slot for transmitting the conflict indicator. A location of the second slot is based on one of the first slot or a slot indicated by the time resource assignment. The conflict indicator indicates a potential resource conflict or a detected resource conflict on at least one of the set of frequency resources or the time resource assignment indicated by the resource reservation.

### CROSS-REFERENCE TO RELATED APPLICATIONS

This patent application is a continuation of International Application No. PCT/US2022/039424, filed Aug. 4, 2022 and entitled “Method and Apparatus of Inter-User Equipment (UE) Coordinations in Sidelink (SL) Communications,” which claims priority to U.S. Provisional Application No. 63/230,548, filed on Aug. 6, 2021 and entitled “Method and Apparatus of Inter UE Coordinations in Sidelink Communications,” and to U.S. Provisional Application No. 63/229,866, filed on Aug. 5, 2021 and entitled “Method and Apparatus of Inter UE Coordinations in Sidelink Communications,” which applications are hereby incorporated by reference as if reproduced in their entireties.

### TECHNICAL FIELD

The present disclosure relates generally to wireless communications, and in particular embodiments, to techniques and mechanisms for inter-UE coordination in sidelink (SL) communications.

### BACKGROUND

The third generation partnership project (3GPP) has been developing and standardizing several features with the fifth generation (5G) new radio (NR) access technology. In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. High data rates, low latencies, and high reliabilities were some of the key areas investigated and standardized.

### SUMMARY

Technical advantages are generally achieved, by embodiments of this disclosure which describe a method and apparatus for sidelink communications of power saving UEs in a shared resource pool.

According to embodiments, a first UE (e.g., UE A) receives from a second UE (e.g., UE B) a sidelink control information (SCI) in a first slot. The SCI comprises a resource reservation for a shared channel. The resource reservation indicates a set of frequency resources and a time resource assignment. The first UE transmits to the second UE a conflict indicator on resources of a feedback channel. The resources of the feedback channel include a second slot for transmitting the conflict indicator. A location of the second slot is based on one of the first slot or a slot indicated by the time resource assignment. The conflict indicator indicates a potential resource conflict or a detected resource conflict on at least one of the set of frequency resources or the time resource assignment indicated by the resource reservation.

In some embodiments, the conflict indicator may indicate the potential resource conflict on the time resource assignment based on sensing or the detected resource conflict on the time resource assignment, or the conflict indicator may indicate the potential resource conflict on the set of frequency resources based on sensing or the detected resource conflict on set of frequency resources. In some embodiments, the location of the second slot may be after and closest to the first slot plus a time gap. In some embodiments, the location of the second slot may be a minimum time before the slot indicated by the time resource assignment. In some embodiments, the location of the second slot based on one of the first slot or the slot indicated by the time resource assignment may be configured by a base station or predefined. In some embodiments, the first UE may be a destination of a transmission of the shared channel from the second UE. In some embodiments, the feedback channel may be a physical sidelink feedback channel (PFSCH). In some embodiments, enablement of transmission of the conflict indicator may be configured by higher layer signaling. In some embodiments, the SCI may further include one-bit information indicating that the second UE can receive the conflict indicator from the first UE. In some embodiments, the SCI may include a fewer number of reserved bits when the second UE is configured to transmit the one-bit information. In some embodiments, the first UE may monitor the set of frequency resources indicated by the time resource assignment in the SCI. In some embodiments, the feedback channel may include a first set of resources and a second set of resources. The first set of resources may carry acknowledgements (ACKs) or negative ACKs (NACKs) for reception of shared channels, and the second set of resources may include the resources of the feedback channel carrying the conflict indicator. In some embodiments, the first set of resources and the second set of resources may be located on different frequency resources. In some embodiments, the first UE may transmit the conflict indicator to the second UE in accordance to a priority indicated in the SCI.

According to embodiments, a second UE (e.g., UE B) transmits to a first UE (e.g., UE A) a sidelink control information (SCI) in a first slot. The resource reservation indicates a set of frequency resources and a time resource assignment. The second UE receives from the first UE a conflict indicator on resources of a feedback channel. The resources of the feedback channel include a second slot for receiving the conflict indicator. A location of the second slot is based on one of the first slot or a slot indicated by the time resource assignment. The conflict indicator indicates a potential resource conflict or a detected resource conflict on at least one of the set of frequency resources or the time resource assignment indicated by the resource reservation.

In some embodiments, the conflict indicator may indicate the potential resource conflict on the time resource assignment based on sensing or the detected resource conflict on the time resource assignment or the conflict indicator may indicate the potential resource conflict on the set of frequency resources based on sensing or the detected resource conflict on set of frequency resources. In some embodiments, the location of the second slot may be after and closest to the first slot plus a time gap. In some embodiments, the location of the second slot may be a minimum time before the slot indicated by the time resource assignment. In some embodiments, the location of the second slot based on one of the first slot or the slot indicated by the time resource assignment may be configured by a base station or predefined. In some embodiments, the first UE may be a destination of a transmission of the shared channel from the second UE. In some embodiments, the feedback channel may be a physical sidelink feedback channel (PFSCH). In some embodiments, enablement of reception of the conflict indicator may be configured by higher layer signaling. In some embodiments, the SCI may further include one-bit information indicating that the second UE can receive the conflict indicator from the first UE. In some embodiments, the SCI may include a fewer number of reserved bits when the second UE is configured to transmit the one-bit information. In some embodiments, the feedback channel includes a first set of resources and a second set of resources, wherein the first set of resources may carry acknowledgements (ACKs) or negative ACKs (NACKs) for reception of shared channels, and the second set of resources may include the resources of the feedback channel carrying the conflict indicator. In some embodiments, the first set of resources and the second set of resources may be located on different frequency resources. In some embodiments, the second UE may receive the conflict indicator from the first UE in accordance to a priority indicated in the SCI.

The above aspects solve the technical problems described in this disclosure, and accordingly reduce resource collisions, improve resource utilization efficiency, improve sidelink communication performance, and reduce sidelink power consumption.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an embodiment communications system;

FIG. 2 is a diagram of example in-coverage (IC) and out-of-coverage (OOC) scenarios in sidelink communication;

FIG. 3 is a diagram of an example resource pool;

FIG. 4 is a diagram of embodiment resources for physical sidelink control channel (PSCCH), physical sidelink shared channel (PSSCH), and physical sidelink feedback channel (PSFCH);

FIGS. 5A and 5B illustrate how the resources are associated to a PSFCH, according to some embodiments;

FIG. 6A illustrates an example of the hidden node problem;

FIG. 6B illustrates an example of the exposed-node problem;

FIG. 6C illustrates an example of the half duplex problem;

FIG. 6D illustrates an example of the consecutive packet loss problem;

FIG. 7 illustrates slot-subchannel allocation of the PSFCH or PSFCH-like channel for coordination information transmissions using PSFCH associated to original scheduled PSSCH as the reference, according to some embodiments;

FIG. 8 illustrates alternative slot-subchannel allocation of the PSFCH or PSFCH-like channel for coordination information transmissions, according to some embodiments;

FIG. 9 illustrates the virtual PSSCH concept for resource allocation of the PSFCH or PSFCH-like channel for coordination information transmissions, according to some embodiments;

FIG. 10 illustrates procedures of inter-UE coordination via a feedback channel, according to some embodiments;

FIG. 11 illustrates PSFCH selection in two PSFCH PRB sets, according to some embodiments;

FIG. 12 illustrates PSFCH resource partition in code domain, according to some embodiments;

FIG. 13 illustrates PSFCH resource partition in the frequency domain, according to some embodiments;

FIG. 14 illustrates example coordination information in the MAC-CE, according to some embodiments;

FIG. 15A illustrates a flow chart of a method for inter-UE coordination in SL communications, according to some embodiments;

FIG. 15B illustrates a flow chart of a method for inter-UE coordination in SL communications, according to some embodiments;

FIG. 16 is a diagram of another embodiment communication system;

FIG. 17A is a diagram of an embodiment end device (ED);

FIG. 17B is a diagram of an embodiment base station; and

FIG. 18 is a block diagram of an embodiment computing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

In Release-17, a work item for sidelink enhancement was approved to further enhance the capabilities and performance of sidelink communications. One of the objectives of the work item is to introduce UE coordination mechanism where one UE (e.g., UE A) provides information about resources to another UE (e.g., UE B) to use in UE B's resource selection.

In this disclosure, several techniques to support inter-UE coordination are described. While the techniques can be used for all UEs, they are especially applicable to public safety (PS) UEs. More details are provided in the following.

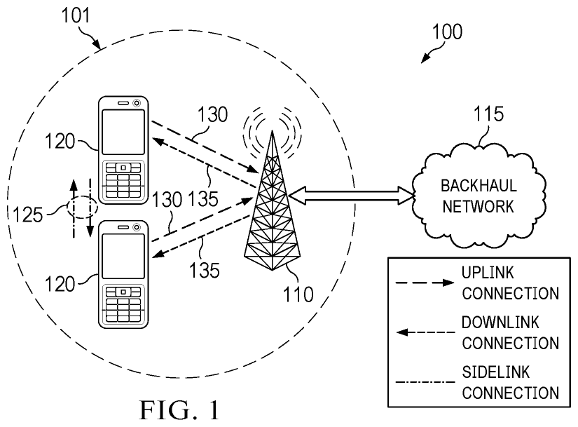

FIG. 1 is a diagram of an embodiment communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE passes through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising uni-directional communication links. Communication in the second operating mode may be referred to as sidelink communication. Communication between a UE and access node pair also occur over uni-directional communication links, where the communication links from UEs 120 to the access node 110 are referred to as uplinks 130, and the communication links from the access node 110 to the UEs 120 are referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

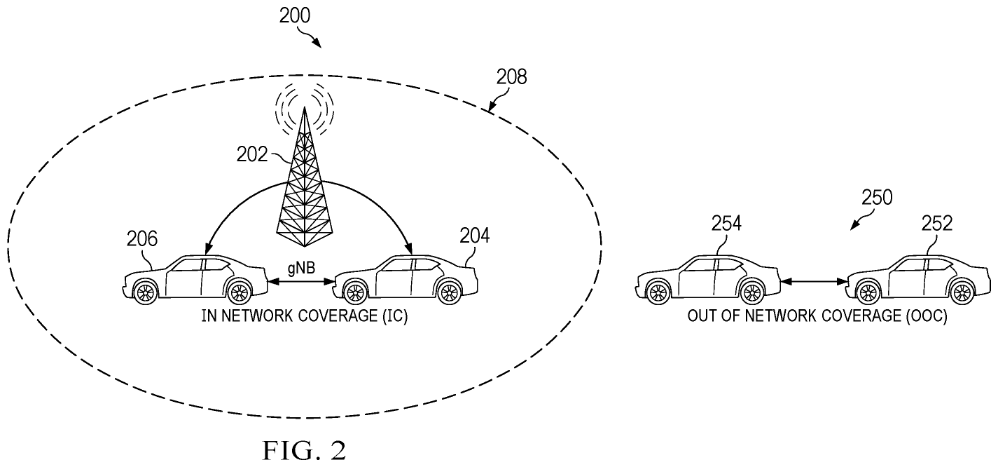

The sidelink communication can either be in-coverage, or out-of-coverage. For mode 1 operation, which is an in-coverage (IC) operation, a central node (e.g., access node, eNB, gNB, etc.) may be present and used to manage sidelinks. For mode 2 operation, the system operation is fully distributed, and UEs select resources on their own. Mode 2 operation is used for out-of-coverage scenarios and also for IC scenarios. FIG. 2 is a diagram showing an example IC scenario 200 and an example OOC scenario 250. In the IC scenario 200, a gNB 202 is configured to manage sidelink communications between UEs 204 and 206 that are in the coverage of the gNB 202. UEs 204 and 206 can be considered as mode 1 UEs. In the OOC scenario 250, UEs 252 and 254 perform sidelink communication with each other without management of a central node, and select resources on their own for the sidelink communication. UEs 252 and 254 can be considered as mode 2 UEs. In an embodiment of the present disclosure, some UEs may be facilitated or assisted to select their resources for sidelink communication.

For the purpose of sidelink communications, the notion of resource pools was introduced for LTE sidelink and is being reused for NR sidelink. A resource pool is a set of resources that may be used for sidelink communication. Resources in a resource pool may be configured for different channels and signals, such as control channels, shared channels, feedback channels, broadcast channels (e.g., a master information block), synchronization signals, reference signals, and so on. 3GPP TS 38.331, “NR; Radio Resource Control (RRC); Protocol specification,” V16.4.1, Mar. 30, 2021, which is herein incorporated by reference, defines rules on how the resources in the resource pool are shared and used for a particular configuration of the resource pool. A UE performing sidelink transmission may select a resource from a resource pool configured for sidelink communication, and transmit signals in the resource on a sidelink.

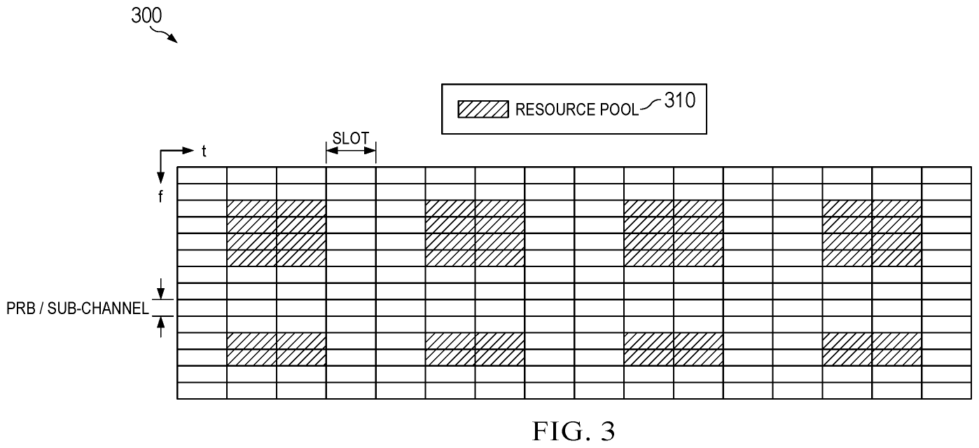

A resource pool for sidelink communication may be configured in units of slots in the time domain and physical resource blocks (PRBs) or sub-channels in the frequency domain. A sub-channel may include one or more PRBs. FIG. 3 is a diagram 300 of an example resource pool in the time-frequency resource grid. FIG. 3 shows a resource pool 310 including a plurality of resources (shaded rectangles) in different slots and PRBs/sub-channels.

According to 3GPP TS 38.211, “NR; Physical channels and modulation,” V16.5.0, Mar. 30, 2021, which is herein incorporated by reference in its entirety, for NR mobile broadband (MBB), each physical resource block (PRB) in the grid is defined as including a slot of 14 consecutive orthogonal frequency division multiplexing (OFDM) symbols in the time domain and 12 consecutive subcarriers in the frequency domain, i.e., each resource block includes 12×14 resource elements (REs). Each RE includes one subcarrier. (When used as a frequency-domain unit, a PRB is 12 consecutive subcarriers.) There are 14 symbols in a slot when a normal cyclic prefix is used, and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. A PRB may be allocated for communicating a channel and/or a signal, e.g., a control channel, a shared channel, a feedback channel, a reference signal, or a combination thereof. In addition, some REs of a PRB may be reserved. A similar time-frequency resource structure may be used on the sidelink as well. A communication resource, e.g., for sidelink communication, may be a PRB, a set of PRBs, a code (if code division multiple access (CDMA) is used, similarly to that used for a physical uplink control channel (PUCCH)), a physical sequence, a set of REs, or a combination thereof.

As used herein, a UE participating in sidelink communication is referred to as a source UE or a transmit UE when the UE is to transmit signals on a sidelink to another UE. A UE participating in sidelink communication is referred to as a destination UE, a receive (or receiving) UE or a recipient, when the UE is to receive signals on a sidelink from another UE. Two UEs communicate with each other on a sidelink are also referred to as a UE pair in sidelink communication.

A physical sidelink control channel (PSCCH) may carry sidelink control information (SCI). A source UE uses the SCI to schedule transmission of data on a physical sidelink shared channel (PSSCH) or reserve a resource for the transmission of the data on the PSSCH. The SCI may convey the time and frequency resources of the PSSCH, and/or parameters for hybrid automatic repeat request (HARQ) process, such as a redundancy version, a process id (or ID), a new data indicator, and resources for the physical sidelink feedback channel (PFSCH). The time and frequency resources of the PSSCH may be referred to as resource assignment or allocation, and may be indicated in the time resource assignment field and/or a frequency resource assignment field, i.e., resource locations. The PFSCH may carry an indication (e.g., a HARQ acknowledgement (HARQ-ACK) or negative acknowledgement (HARQ-NACK)) indicating whether a destination UE decoded the payload carried on the PSSCH correctly. The SCI may also carry a bit field indicating or identifying the source UE. In addition, the SCI may carry a bit field indicating or identifying the destination UE. The SCI may further include other fields to carry information such as a modulation coding scheme used to encode the payload and modulate the coded payload bits, a demodulation reference signal (DMRS) pattern, antenna ports, a priority of the payload (transmission), and so on. A sensing UE performs sensing on a sidelink, i.e., receiving a PSCCH sent by another UE, and decoding SCI carried in the PSCCH to obtain information of resources reserved by the another UE, and determining resources for sidelink transmissions of the sensing UE.

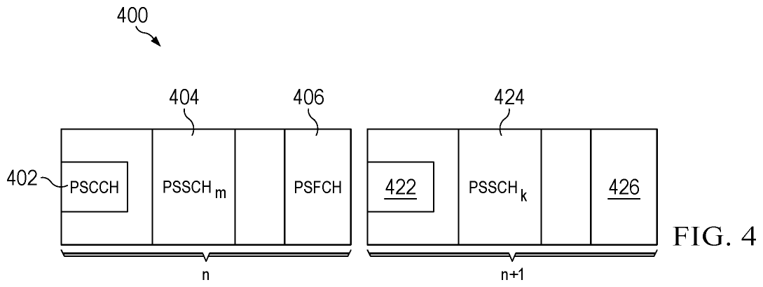

FIG. 4 is a diagram 400 of embodiment resources for PSCCH, PSSCH and physical sidelink feedback channel (PSFCH). FIG. 4 shows the resources in slot n and slot n+1. Within slot n, there are a resource region 402 for PSCCH, a resource region 404 for PSSCH (PSSCHₘ as shown), a resource region 406 for PSFCH. Within slot n+1, there are a resource region 422 for PSCCH, a resource region 424 for PSSCH (PSSCHₖ as shown), and a resource region 426 for PSFCH.

In NR, there are two stages of the SCI: a first stage (shown below) and a second stage. The first stage SCI may indicate the resources for the second stage SCI. A first stage SCI can be transmitted in the PSCCH. A second stage SCI can be transmitted in the PSSCH. The SCI may have the following formats: SCI format 1-A, SCI format 2-A and SCI format 2-B.

### SCI FORMAT 1-A: One Type of First Stage SCI

SCI format 1-A is used for scheduling of PSSCH and 2nd-stage-SCI on PSSCH (according to 3GPP TS 38.212, “NR; Multiplexing and channel coding,” v16.5.0, March 30, 2021, which is hereby incorporated herein by reference in its entirety).

The following information is transmitted by means of the SCI format 1-A:
Priority—3 bits as specified in clause 5.4.3.3 of TS 23.287 and clause 5.22.1.3.1 of TS 38.321.
Frequency resource assignment—

$$⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3, as defined in clause 8.1.5 of TS 38.214.
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of TS 38.214.
Resource reservation period—┌log₂ N_{rsv_period}┐ bits as defined in clause 16.4 of TS 38.213, where N_{rsv_period} is the number of entries in the higher layer parameter sl-ResourceReservePeriodList, if higher layer parameter sl-MultiReserveResource is configured; 0 bit otherwise.
DMRS pattern—┌log₂ Nₚₐₜₜₑᵣₙ┐ bits as defined in clause 8.4.1.1.2 of TS 38.211, where Nₚₐₜₜₑᵣₙ is the number of DMRS patterns configured by higher layer parameter sl-PSSCH-DMRS-TimePatternList.
2^{nd}-stage SCI format—2 bits as defined in Table 8.3.1.1-1 of TS 38.212.
Beta_offset indicator—2 bits as provided by higher layer parameter sl-BetaOffsets2ndSCI and Table 8.3.1.1-2 of TS 38.212.
Number of DMRS port—1 bit as defined in Table 8.3.1.1-3 of TS 38.212.
Modulation and coding scheme—5 bits as defined in clause 8.1.3 of TS 38.214.
Additional MCS table indicator—as defined in clause 8.1.3.1 of TS 38.214: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of TS 38.214 if higher layer parameter sl-PSFCH-Period=2 or 4; 0 bit otherwise.
Reserved—a number of bits as determined by higher layer parameter sl-NumReservedBits, with value set to zero.

TS 38.321, “3rd Generation Partnership Project; Technical Specification Group Radio Access Network; NR; Medium Access Control (MAC) protocol specification (Release 16),” v 16.4.0, Mar. 29, 2021, and TS 23.287, “3rd Generation Partnership Project; Technical Specification Group Services and System Aspects; Architecture enhancements for 5G System (5GS) to support Vehicle-to-Everything (V2X) services (Release 16),” v 16.5.0, December 2020, are herein incorporated by reference in their entireties.

### SCI FORMAT 2-A: One Type of Second Stage SCI

SCI format 2-A is used for the decoding of PSSCH, with HARQ operation when HARQ-ACK information includes ACK or NACK, or when there is no feedback of HARQ-ACK information.

The following information may be transmitted by means of the SCI format 2-A (according to 3GPP TS 38.212):
HARQ process number—┌log₂ N_{process}┐ bits as defined in clause 16.4 of TS 38.213, “NR; Physical layer procedures for control,” v16.5.0, Mar. 30, 2021, which is hereby incorporated herein by reference in its entirety.
New data indicator—1 bit as defined in clause 16.4 of TS 38.213.
Redundancy version—2 bits as defined in clause 16.4 of TS 38.214, “NR; Physical layer procedures for data,” v16.5.0, Mar. 30, 2021, which is hereby incorporated herein by reference in its entirety.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Cast type indicator—2 bits as defined in Table 8.4.1.1-1 of TS 38.212.
CSI request—1 bit as defined in clause 8.2.1 of TS 38.214.

Table 8.4.1.1-1 of TS 38.212 is provided below.

TABLE 8.4.1.1-1
Cast type indicator

| Value of Cast type | |
|---|---|
| indicator | Cast type |
| 00 | Broadcast |
| 01 | Groupcast |
| 10 | Unicast |
| 11 | Reserved |

### SCI FORMAT 2-B: Another Type of Second Stage SCI

SCI format 2-B is used for the decoding of PSSCH, with HARQ operation when HARQ-ACK information includes only NACK, or when there is no feedback of HARQ-ACK information.

The following information may be transmitted by means of the SCI format 2-B (according to TS 38.212):
HARQ process number—┌log₂ N_{process}┐ bits as defined in clause 16.4 of TS 38.213.
New data indicator—1 bit as defined in clause 16.4 of TS 38.213.
Redundancy version—2 bits as defined in clause 16.4 of TS 38.214.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Zone ID—12 bits as defined in clause 5.8.1.1 of TS 38.331 which is hereby incorporated herein by reference in its entirety.
Communication range requirement—4 bits as defined in TS 38.331.

TS 38.331 specifies higher layer messages for configuring PSCCH, and specifies an information element (IE) SL-PSCCH-Config-r16 as shown below:

SL-PSCCH-Config-r16 ::= SEQUENCE {
sl-TimeResourcePSCCH-r16 ENUMERATED {n2, n3} OPTIONAL, --
Need M
sl-FreqResourcePSCCH-r16 ENUMERATED {n10,n12, n15, n20, n25}
OPTIONAL, -- Need M
sl-DMRS-ScrambleID-r16 INTEGER (0..65535) OPTIONAL, -- Need M
sl-NumReservedBits-r16 INTEGER (2..4) OPTIONAL, -- Need M
...
}

SL-PSCCH field descriptions

sl-FreqResourcePSCCH
Indicates the number of PRBs for PSCCH in a resource pool where it is
not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

In Release-16, 3GPP introduced NR sidelink communication between devices such as UEs, in addition to the typical Downlink and Uplink transmission. Sidelink-communication capable devices may regularly exchange control/data information with each other.

In Release-16, two mechanisms, namely, re-evaluation and pre-emption, were introduced in sidelink communications to reduce the collision probability and improve the packet reception ratio (PRR) performance.

Re-evaluation mechanism: After a transmit UE selects a sidelink resource and reserves the selected sidelink resource, it can continue a sensing process to check whether the reserved resource is still available. To achieve this, the UE may keep monitoring SCI on sidelink resources and perform a resource selection procedure, e.g., the procedure as defined in TS38.214, Section 8.1.4, performing a resource exclusion process in a reduced resource selection window based on sensing outcome to form an available resource set. If the reserved resource is not in the available resource set, the UE performs resource re-selection and selects a new resource to avoid any potential collision. As an example, the UE may determine, from a resource pool, a set of resources that is available for the UE to use for sidelink communication. The UE may select a resource from the available resource set and reserves the selected resource. The UE may then re-determine the resource set, e.g., by excluding one or more resources that are not available (e.g., based on a received SCI indicating a resource reserved by another UE) or adding one or more resources that are available. The UE may check whether the selected resource is included in the re-determined resource set (or referred to as an updated resource set). If the selected resource is not included in the re-determined resource set (which may indicate that this resource is not available for the UE anymore), the UE may re-select a resource from the re-determined resource set for sidelink communication.

Pre-emption mechanism: After a transmit UE (e.g., UE1) selects and reserves a sidelink resource, it can continue a sensing process to check whether the reserved resource is still available, as described above. In an example, UE1 may find out that the reserved resource is not included in the updated available resource set and occupied by another UE (e.g., UE2), e.g., by decoding SCI 1-A from UE2. UE2 may be referred to as a collided UE. In this case, UE1 may detect a priority of data to be transmitted by UE2. If a priority of data to be transmitted by UE1 (referred to as a sensing UE, as it performs the sensing process) is lower than that of the UE2's data, the sensing UE (UE1) may release its reserved resource and re-select a resource in the resource selection window, e.g., in the updated available resource set. If UE1's data has a higher priority, UE1 may continue to reserve the resource and transmit its data using the reserved resource on sidelink.

There are 8 packet priority levels for sidelink data traffic, i.e., 1, 2, . . . , 8, indicated by a 3-bit number p in a priority field in SCI format 1-A. The values of p are from 0 to 7, and a value of a priority (or priority level) is equal to p+1. It is noted that a smaller or lower value (p+1) of priority indicates a higher priority (level) according to TS23.303, “Proximity-based services (ProSe); Stage 2,” 16.0.0, Jul. 9, 2020, which is hereby incorporated herein by reference in its entirety. The smallest value of priority, i.e., 1, indicates the highest priority, and the largest value of priority, i.e., 8, indicates the lowest priority level.

The priority level of sidelink data may be set by the application layer and is provided to the physical layer.

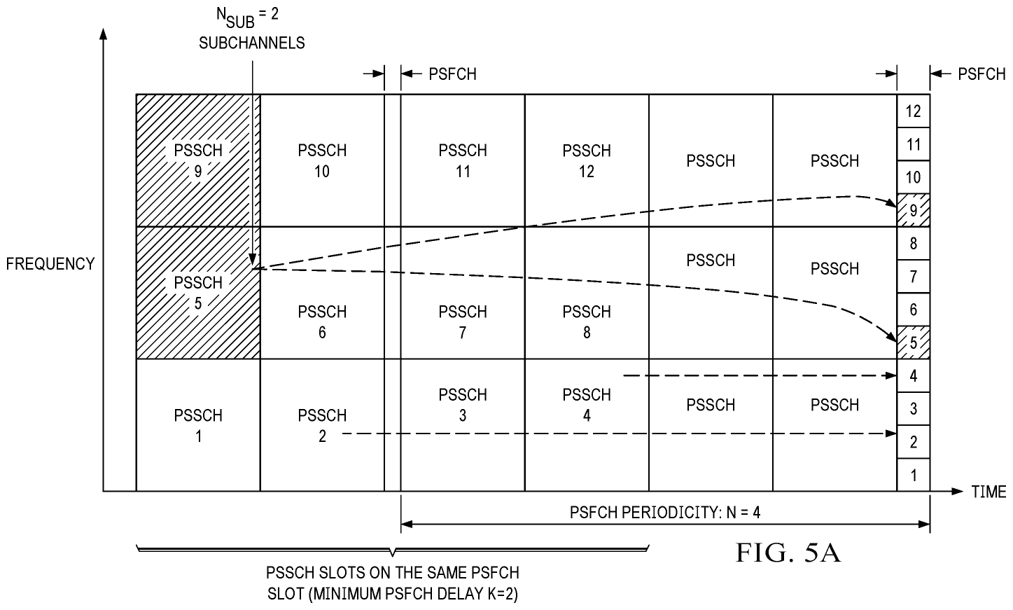

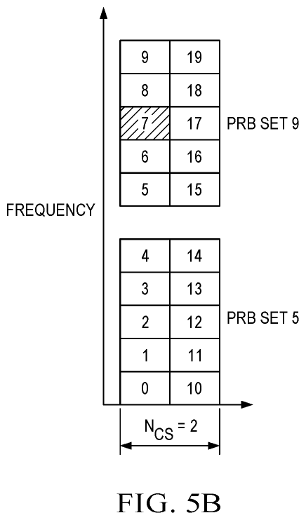

For unicast and groupcast, the acknowledgement (ACK)/negative ACK (NACK) feedback can be configured and transmitted in the physical sidelink feedback channel (PSFCH). PSFCH resources are then associated for each physical sidelink shared channel (PSSCH) transmission. FIGS. 5A and 5B illustrate how the resources are associated to a PSFCH. FIG. 5A shows PRB set allocation and the mapping of PRBs into the PFSCH. The periodicity of PSFCH is N=4, and PRB sets for PSFCH is 4/subchannel. The minimum number of slots for PSFCH delay is K=2. In one example, a PSSCH may occupy 2 subchannels (N_{sub}=2). FIG. 5B shows a mapping of the PSFCH, with M_{S}=5 PRBs/set of PRB resources, and the number of cyclic shifts N_{CS}=2.

As shown in FIG. 5A, each PSSCH transmission is associated with one or a set of PSFCHs. The resources for the PSFCH can be configured to be available once every N slots, where N is the PSFCH period (N=4 in FIG. 5A). There is also a processing delay. So the gap between the slot for the PSFCH to the corresponding PSSCH slot is no less than K. In the example shown in FIG. 5A, K=2. Since N=4, then for each subchannel, there are 4 sets of PRB resources and each set for a PSFCH association. If a PSSCH transmission occupies more than one subchannel, e.g., N_{sub} subchannels, the PSFCH can be selected from N_{sub} sets of PRB resources. As shown in FIG. 5A, one PSSCH transmission occupies two subchannels (on PSSCH sets of PRB resources 5 and 9). The corresponding PSFCH can be selected from N_{sub} sets of PRB resources, i.e., the sets 5 and 9 for the PSFCH association in the end. Alternatively, if PSSCH occupies N_{sub}>1 subchannels, the UE can still select one set of PRB resources for PSFCH allocation, i.e., based on the starting subchannel. For the same example shown in FIG. 5A with two subchannels, the PSFCH can be associated in set 5 only. Each set of PRB resources has M_{S} PRBs, and each PRB can be assigned for one PSFCH transmission. In addition, the same PRB can be reused for additional PSFCH transmissions which is achieved with different cyclic shifts of the sequence for HARQ-ACK. The reuse factor is determined by number of cyclic shifts N_{CS}. N_{CS} can be configured from {1, 2, 3, 6}. Therefore, for a PSSCH occupying N_{sub} subchannels, there are total L=N_{sub}*M_{S}*N_{CS} PSFCH resources if using N_{sub} PSFCH sets of PRB resources or L=M_{S}*N_{CS} PSFCH resources if using one sets of PRB resources corresponding to the PSSCH starting subchannel. In the example in FIG. 5B, M_{S}=5, N_{CS}=2, and two sets of PRB resources corresponding to the PSSCH with 2 subchannels in FIG. 5A. There are total 20 PSFCH resources. The rule defined in 5G NR release-16 is that the receive UE selects the jth PSFCH resource according to

j=(T_{ID}+R_{ID})mod L

In the above equation, T_{ID} is the layer 1 ID of transmit UE, (i.e., the source ID in the 2^{nd} stage SCI), and R_{ID}=0 for unicast ACK/NACK feedback or groupcast option 1 NACK-only feedback. For groupcast option 2 ACK/NACK feedback R_{ID} is the receiver ID in the group from the higher layers. As shown in FIG. 5B, j=7 in the example case.

The configuration of NCS and corresponding cyclic shift pair index is specified in Table 16.3-1 from TS38.213, reproduced below.

TABLE 16.3-1
Set of cyclic shift pairs (From TS38.213)

| | m₀ | | | | | |
|---|---|---|---|---|---|---|
| | Cyclic Shift | Cyclic Shift | Cyclic Shift | Cyclic Shift | Cyclic Shift | Cyclic Shift |
| | Pair Index | Pair Index | Pair Index | Pair Index | Pair Index | Pair Index |
| N_{CS}^{PSFCH} | 0 | 1 | 2 | 3 | 4 | 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

The HARQ-ACK 1-bit message is also carried by the sequence with different cyclic shifts. The cyclic shift index to ACK/NACK mapping is specified in Table 16.3-2 from TS38.213, i.e., 0 for NACK and 6 for ACK. For groupcast option 1 HARQ, NACK-only message is sent on PSFCH, only one NACK state is needed. The mapping for NACK message is provided in Table 16.3-3 from TS38.213, i.e., 0 for NACK, which is consistent with the value for ACK/NACK feedback.

TABLE 16.3-2
Mapping of HARQ-ACK information bit values to a cyclic shift,
from a cyclic shift pair, of a sequence for a PSFCH transmission
when HARQ-ACK information includes ACK or NACK

| HARQ-ACK Value | 0 (NACK) | 1 (ACK) |
|---|---|---|
| Sequence cyclic shift | 0 | 6 |

TABLE 16.3-3
Mapping of HARQ-ACK information bit values to a cyclic shift,
from a cyclic shift pair, of a sequence for a PSFCH transmission
when HARQ-ACK information includes only NACK

| HARQ-ACK Value | 0 (NACK) | 1 (ACK) |
|---|---|---|
| Sequence cyclic shift | 0 | N/A |

At RANP #86, a Release-17 work item on sidelink enhancements was agreed (RP-193257) with the following objective on resource allocation enhancements to enhance sidelink reliability:
Study the feasibility and benefit of the enhancement(s) in mode 2 for enhanced reliability and reduced latency in consideration of both PRR and Packet Inter-Reception (PIR) defined in TR37.885 (by RAN #91), and specify the identified solution if deemed feasible and beneficial [RAN1, RAN2]
Inter-UE coordination with the following:
A set of resources is determined at UE A. This set is sent to UE B in mode 2, and UE B takes this into account in the resource selection for its own transmission.

In Release-16 NR V2X sidelink, mode 2 UEs transmit and receive information without network management. UEs themselves allocate the resources from a resource pool for sidelink transmissions. However, since in Release-16, the transmitter performs sensing and resource selection, there are several technical problems that degrade the sidelink performance, such as:
Hidden-node problem
Exposed-node problem
Half duplex problem
Consecutive packet loss.

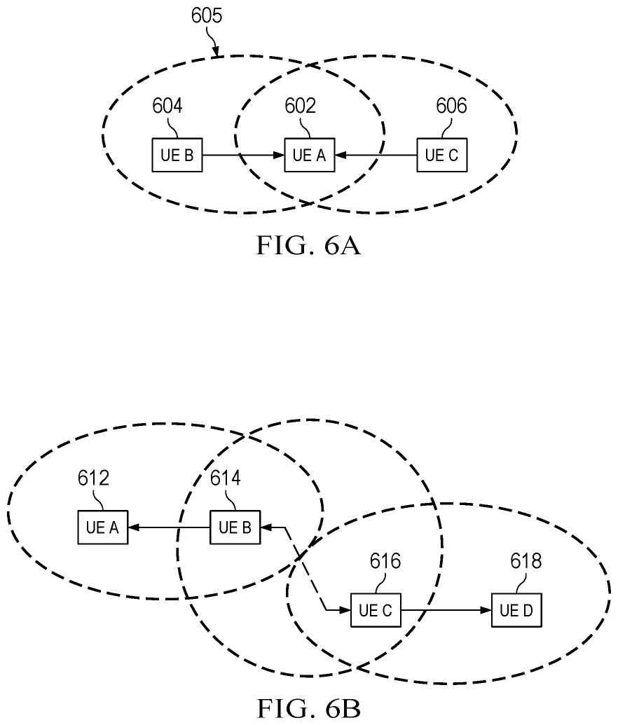

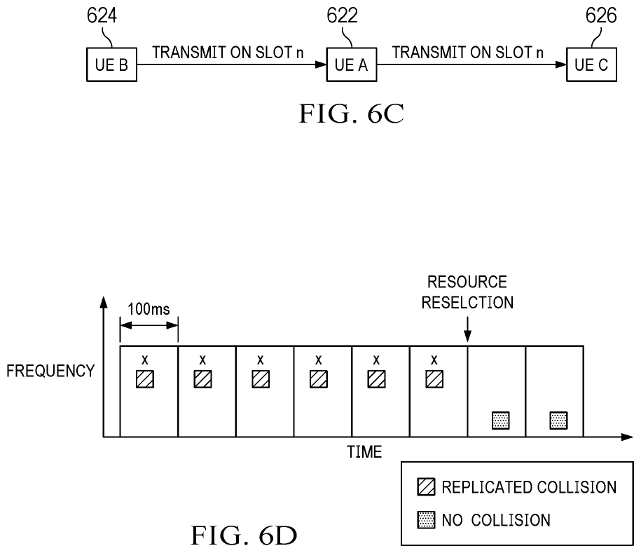

FIG. 6A illustrates an example of the hidden node problem. In FIG. 6A, UE B 604 selects the resource for the data transmission to UE A 602. Since resource selection is performed at UE B 604 based on its own sensing results, UE B 604 will not detect the resource reservation from UE C 606 if UE C 606 is not in the coverage area 605 of UE B 604. Then, when both UE B 604 and UE C 606 select the same resource (e.g., the same resource in the time domain and in the frequency domain) for their transmissions, a conflict occurs. UE A 602 may not receive transmissions from UE B 604 due to interference from UE C 606's transmission, regardless of whether UE A 602 is the recipient of UE C 606's transmission or not.

FIG. 6B illustrates an example of the exposed-node problem. In FIG. 6B, both UE B 614 and UE C 616 select resources and transmit to UE A 612 and UE D 618, respectively. Since UE B 614 and UE C 616 are in coverage of each other, UE B 614 and UE C 616 will select different resources (e.g., different resources in the time domain and/or in the frequency domain) based on their sensing results to avoid conflicts. However, because UE A 612 is outside the coverage area of UE C 616, and UE D 618 is outside the coverage area of UE B 614, it is acceptable that UE B 614 and UE C 616 reserve the same resources for their transmission. Therefore, such exposed node problem results in inefficient resource utilization and causes a higher resource conflict with other UEs.

FIG. 6C illustrates an example of the half duplex problem. In FIG. 6C, if UE B 624 transmits a packet to UE A 622 on some resources in a slot, UE A 622 may not be able to receive the transmission as UE A 622 may be transmitting to another UE (e.g., UE C 626). This is a half-duplex problem as a device cannot transmit and receive on the same carrier based on the current standard. Another scenario for this problem is that UE A 622 has an uplink transmission to the base station scheduled on the same time slot when UE B 624 transmits the sideline transmission.

FIG. 6D illustrates an example of the consecutive packet loss problem. In FIG. 6D, when two UEs, with the same traffic periodicity or when a periodicity of one UE is a multiple of the periodicity of the other UE, reserve the same resources, the initial collision is then replicated, resulting in consecutive packet loss (e.g., possibly caused by the half duplex problem or by the hidden mode problem) until resource reselection.

To solve the above technical problems and to improve the reliability of the sidelink transmissions, inter-UE coordination may be considered, in which a UE (UE A), sends coordination information (e.g., a set of resources) to the transmitting UE (e.g., UE B), to assist UE B with resource selection to avoid resource conflicts in the scenarios described above. Inter-UE coordination was agreed and included in a work item for the sidelink enhancement in 3GPP Release-17 standardization.

In Release 17 (and RAN1 #104-e meeting), it was agreed that three types of “A set of resources” as specified in the work item description (RP-193257) may be used for inter-UE coordination in Mode 2.
Type A: UE A sends to UE B the set of resources preferred for UE B's transmission (e.g., based on UE A's sensing result).
Type B: UE A sends to UE B the set of resources not preferred for UE B's transmission (e.g., based on UE A's sensing result and/or expected/potential resource conflict).
Type C: UE A sends to UE B the set of resource where the resource conflict is detected.

In Release-17 (and RAN1 #104b-e meeting), it was further agreed that two inter-UE coordination schemes below are supported in Release-17.
Inter-UE Coordination Scheme 1:
The coordination information sent from UE A to UE B includes the set of resources preferred and/or non-preferred for UE B's transmission.
For future study (FFS) details including a possibility of down-selection between the preferred resource set and the non-preferred resource set, whether or not to include any additional information other than indicating time/frequency of the resources within the set in the coordination information,
FFS condition(s) in which Scheme 1 is used.
Inter-UE Coordination Scheme 2:
The coordination information sent from UE A to UE B includes the presence of expected/potential and/or detected resource conflict on the resources indicated by UE B's SCI.
FFS details including a possibility of down-selection between the expected/potential conflict and the detected resource conflict.
FFS condition(s) in which Scheme 2 is used.

Inter-UE coordination scheme 2 is examined in this disclosure. However, the presented methods and designs may not be limited to scheme 2, and at least some methods and designs can be applied to inter-UE coordination scheme 1 whenever it is appropriate (e.g., coordination triggering/configuration).

In inter-UE coordination scheme 2 for sidelink, the coordination information sent from UE A to UE B (UE B selects the resources for sidelink transmissions) indicates the presence of expected/potential and/or detected resource conflict on the resources indicated by UE B's SCI. UE B then takes the coordination information into account in the resource selection for its own transmission. The resource conflict can be the result from another UE reserving the same resource as in the case of hidden-node or UE A (or another receive UE) scheduling the same resource for its own transmission.

With a common understanding, a difference between scheme 1 and scheme 2 is that, in scheme 2, the coordinating UE (e.g., UE A) generates the coordination information after receiving the SCI for resource allocations from UE B (e.g., the transmit UE), while in scheme 1, the coordination information is generated before receiving the SCI containing sidelink resource selection.

For scheme 2, an embodiment method is for the UE A to send a one-bit indicator to let UE B know if a conflict happened (or may happen). The PSFCH or PSFCH-like channel may be utilized for the conflict indication in scheme 2.

This disclosure provides an efficient design of resource allocation and mapping of the PSFCH or PSFCH-like channel for conflict indication, including how to assign slot/subchannel/PRB sets for PSFCH for coordination information and which channel in the PSFCH PRB sets is used. PSFCH resource partitioning is provided to avoid or mitigate PSFCH collisions. A modified PSFCH format for conflict indicating or carrying additional information is provided.

In addition, medium access control (MAC)-control element (MAC-CE) can be used to carry the coordination information, which may be more flexible and can carry more information. The means for coordination triggering are also provided in this disclosure.

As further described below, this disclosure provides efficient resource allocation and mapping rules for the PSFCH or PSFCH-like channel for conflict indication, which may include:
efficient PSFCH association achieved by one or set of configurable parameters,
introduction of an offset on the PSFCH selection in PSFCH PRB sets to handle potential PSFCH collision,
the resource association specified with the association between the PSFCH and a virtual PSSCH and reusing most existing association rules.

As further described below, embodiments of this disclosure also provide the modified PSFCH format or a new format using PSFCH for conflict indication, which may include:
adding one or more state(s) in the existing PSFCH format for carrying coordination information (e.g., conflict indication, conflict type, etc.),
a new, general, format using existing PSFCH,
addition of the base sequence configuration for collision avoidance and/or carrying more bits.

Embodiments of this disclose also provide techniques for sending coordination information via PSFCH or PSFCH-like channels for scheme 2 for expected/potential conflicts and detected conflicts. The coordination information can be 1 bit or 1 state in the mapping table of PSFCH format for conflict indication only, or the coordination information can be multiple bits to carry the conflict indicator and other coordination information.

For expected/potential conflicts, UE A may send the coordination information such as conflict indication before the transmission of the scheduled PSSCH so that UE B can reselect the resource to avoid the expected/potential conflict. Therefore, there is no associated PSFCH resource for the conflict indicator. The rules for resource allocation of PSFCH or PSFCH-like channel for sending coordination information may be specified. An efficient method is provided for the subchannel and frequency allocation, as well as PRB set allocations. The specific PSFCH allocation is described below.

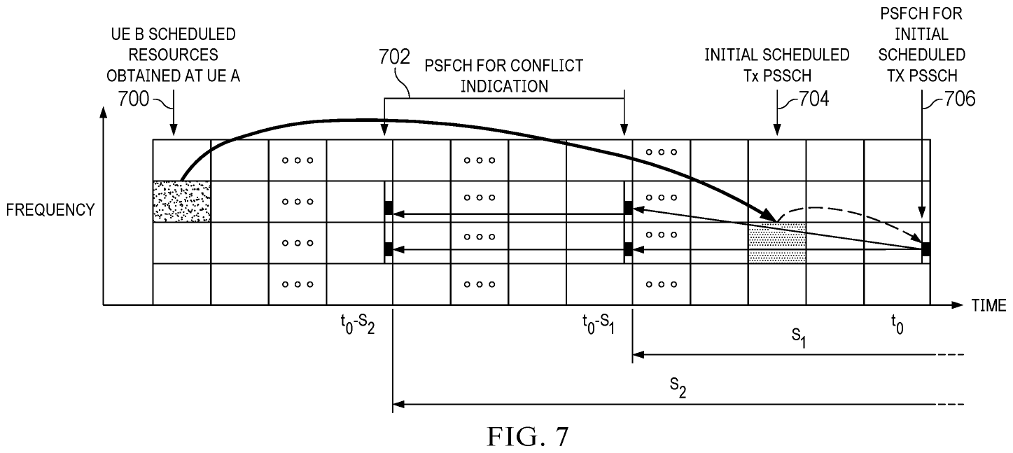

FIG. 7 illustrates slot-subchannel allocation of the PSFCH or PSFCH-like channel for coordination information transmissions using PSFCH associated to original scheduled PSSCH as the reference, according to some embodiments.

FIG. 7 shows using the SCI slot 700 where UE A obtained the UE B scheduled resources as the reference slot. As shown in FIG. 7, UE A can be (pre-)configured (e.g., predefined or configured by the base station) with one or more PSFCH slots 702 ahead of the scheduled PSSCH transmission 704 for delivering the coordination information. The configurations can be one or set of values {S₁, S₂, . . . , S_{MS}}, indicating the slot difference from a reference slot 706, e.g., slot 706 of the PSFCH associated with the initial scheduled PSSCH transmission 704, where Mₛ is the maximum number of time instances for sending coordination information. Note that Mₛ can be configured as 1 or set to be 1 by default, meaning that only one slot with PSFCH is configured for sending coordination information and UE B only detects that PSFCH for the coordination information. Also without loss of generality, it is assumed that S₁<S₂< . . . <S_{Ms}. Although the strict inequality is used here, as in the next subsection, if multiple PSFCHs are configured in one slot and if they are combined for a joint set of resource indication, equality can be possible, i.e., S₁≤S₂≤ . . . ≤S_{Ms}.

Assuming that PSFCH for initial scheduled PSSCH 704 is on slot t₀ 706, UE A can send the coordination information via PSFCH resource on one of the slots 702: t₀−S₁, t₀−S₂, . . . , t₀−S_{Ms}. Since the PSFCH periodicity is N, the difference between any two Sᵢ values shall be multiples of N, i.e., Sⱼ−Sᵢ=l*N, l is an integer. Since Sⱼ is a timing offset to indicate the slot before the reference slot 706, it can be viewed as timing advance parameters. In addition, to allow sufficient time for UE B's reaction to the coordination information, e.g., sensing and resource reselection, a minimum timing advance for coordination information, or a minimum Sₘᵢₙ, may be specified or configured and the coordination information or conflict indication must be sent out from UE A before or on slot t₀−Sₘᵢₙ. This results in S₁≥Sₘᵢₙ. Since here the reference slot 706 is a PSFCH slot and the slots indicated by timing advance parameters are also PSFCH slots, the Sⱼ is also multiple of N. Then, instead of configuring {Sⱼ}, the values of {sⱼ=Sⱼ/N} may be configured.

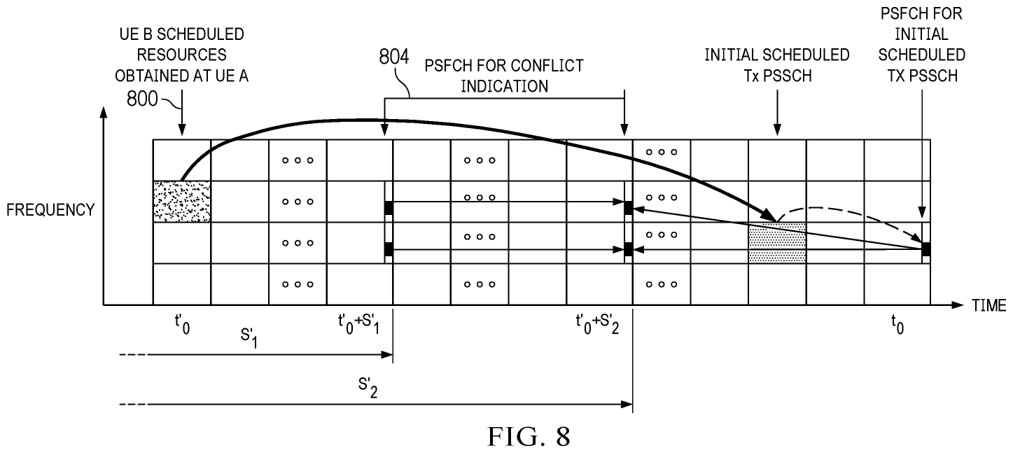

FIG. 8 illustrates alternative slot-subchannel allocation of the PSFCH or PSFCH-like channel for coordination information transmissions, according to some embodiments. FIG. 8 shows using the SCI slot 800 where UE A obtained the UE B scheduled resources as the reference slot. As shown in FIG. 8, a set of values, e.g., {S′₁, S′₂, . . . , S′_{Ms}}, may be specified to indicate the slot differences from the SCI transmission slot 800 where the UE A receives PSSCH resource reservation, i.e., the SCI transmission as the reference slot. Assuming that the reference slot 800 for the SCI transmission is t′₀, UE A can send the coordination information via PSFCH resource on one of the slots t′₀+S′₁, t′₀+S′₂, . . . , t′₀+S′_{Ms}. Although there may not be PSFCH on SCI slot 800, the values of S′ᵢ can be adjusted so that the slots t′₀+S′ⱼ can be slots with PSFCH. However, since slot t′₀ is dynamic, in order to configure the slots t′₀+S′ⱼ on the PSFCH slots, S′ⱼ needs to be dynamic, too. However, signaling {S′ⱼ} in the physical layer (PHY) can be costly given a large signal overhead. If S′ⱼ is semi-statically configured by higher layer, the slots t′₀+S′ⱼ may not be the PSFCH slots. To solve this issue, a rule may be specified such that each PSFCH slot 804 allocated for coordination information transmissions is the PSFCH slot that is later but the closest to the slot t′₀+S′ⱼ. If there are sufficient sensing results available at UE A or some scheduled transmissions for UE A (e.g., the half duplex issue explained above) are already known at UE A, a simple rule may be specified as follows. After UE A receives the scheduled resource from UE B, on the first available slot with PSFCH, UE A transmits the coordination information such as conflict indication. The subchannel and PRB sets can be obtained via the same rules described next and the associated PSFCH in the PSFCH PRB sets can be obtained based on the rules/methods described in below.

Alternatively, the subchannel for the PSFCH carrying coordination information can be configured by explicit subchannel location or an offset over a reference subchannel such as the PSFCH subchannel associated with initial scheduled PSSCH or the subchannel of the SCI. For example, denote f₀ as the reference subchannel index. The subchannel of PSFCH(s) for coordination can be specified by subchannel offset Δf₁, . . . , Δf_{Ms} (i.e., (f₀Δf₁) % F_{Tot}, . . . , (f₀+Δf_{Ms}) % F_{Tot}, where F_{Tot} is the total number of subchannels in resource pool, and % denotes the modulo operation.

Once the subchannel and slot of PSFCH are specified, as shown in FIGS. 5A and 5B, certain PSFCH PRB sets may be specified for PSFCH mapping. Also shown in FIGS. 5A and 5B, the PSFCH PRB sets may be determined based on the PSSCH allocation. For the transmission of the coordination information, the PSFCH PRB sets may be specified based on one of the following options:
The coordination PSFCH PRB sets on configured slot/subchannels based on settings of timing advances, e.g., {S₁, S₂, . . . , S_{Ms} }, can be the same as that of the PSFCH slot/subchannels for the initially scheduled PSSCH.
The coordination PSFCH PRB sets on the configured slot/subchannel based on settings of timing advances, e.g., {S₁, S₂, . . . , S_{Ms}}, are determined based on the specific configuration from higher layers or by the dynamic signaling sent in SCI.

Alternatively, a time window may be specified or (pre-)configured between the resource reservation slot and initial scheduled TX PSSCH slot. After UE B sends the SCI for the resource reservation information, UE B will monitor the feedback channel for the coordination information within the time window. UE A must send the coordination information within the time window. The time window can be specified by two timing offsets, S₁* and S₂*, on a reference slot t₀, i.e., [t₀−S₂*, t₀−S₁*]. An association of the feedback channel in time domain for sending coordination information may be specified as on every PSFCH slot within the time window. The subchannel/PRB set locations can be derived via the same principles described above. Then, the configured parameters can be reduced to the minimum of only two parameters on the slot location.

Container of timing parameter settings: The slot timing advances {S₁, S₂, . . . , S_{Ms}} or {S′₁, S′₂, . . . , S′_{Ms}} can be configured by higher layers, e.g., RRC parameters, or sent in SCI, particularly, the second stage SCI. If sent through SCI by UE B, it can be packed in the SCI that contains the initial resource reservations, and similarly, for subchannel offsets and/or PSFCH PRB set indices if they are needed.

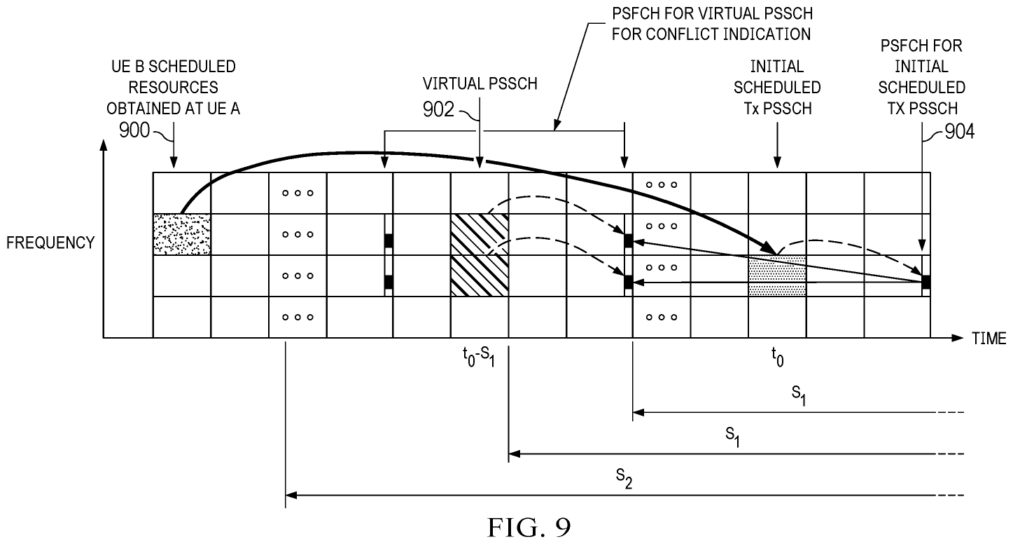

FIG. 9 illustrates the virtual PSSCH concept for resource allocation of the PSFCH or PSFCH-like channel for coordination information transmissions, according to some embodiments. FIG. 9 shows using the SCI slot 900 where UE A obtained the UE B scheduled resources as the reference slot. The resource configuration or association of the PSFCH or PSFCH-like channel described above for coordination information may be explained with a virtual PSSCH concept. Since each PSFCH is associated to a certain PSSCH, the allocated PSFCH for coordination information may be on the same PSFCH PRB set or even the same PSFCH associated to a PSSCH transmission. Therefore, as shown in FIG. 9, the slot and subchannel allocations for a PSFCH for coordination can be viewed as the PSFCH associated to a mirrored or a virtual PSSCH transmission 902 that is ahead of the initial scheduled PSSCH 904. Therefore, one or more PSFCHs for coordination can be configured via scheduling the virtual PSSCHs 902 using the existing SCI with a new bit to indicate that the PSSCH resource reservation is for referring the feedback channel for sending the coordination. Alternatively, the PSFCH allocation for coordination can be configured via the timing advance of the virtual PSSCH 902 over the initial scheduled PSSCH 904 as the reference point which can also be Sⱼ, j=1, . . . , M_{S}. Also, with the virtual PSSCH concept, the PSFCH PRB sets can also be determined based on the mapping between the PSFCH PRB sets and virtual PSSCH locations in Release-16 shown in FIGS. 5A and 5B. Therefore, the procedures may be summarized as follows:
given the slot index to for the initially reserved PSSCH 904, according to the configured timing advances S₁, . . . , S_{Ms}, obtain the slots 902 for the virtual PSSCHs, t₀−S₁, t₀−S₂, . . . , t₀−S_{Ms},
obtain the subchannel of the virtual PSSCHs 902, similarly as above, which may be aligned with the subchannel of reserved PSSCH, the subchannel of SCI, or the subchannel of reserved PSSCH with an offset,
obtain the PSFCH PRB set for the virtual PSSCH 902 according to the same rule for the real PSSCH on the same resources.

With virtual PSSCH configurations, the timing advance values Sⱼ may be arbitrary, meaning that, in general, Sⱼ or Sⱼ−Sᵢ need not be the multiples of PSFCH period N. This feature facilitates the higher layer semi-static configuration. But rules of Sⱼ or Sⱼ−Sᵢ being multiples of N may still be specified for easier PSFCH conflict management.

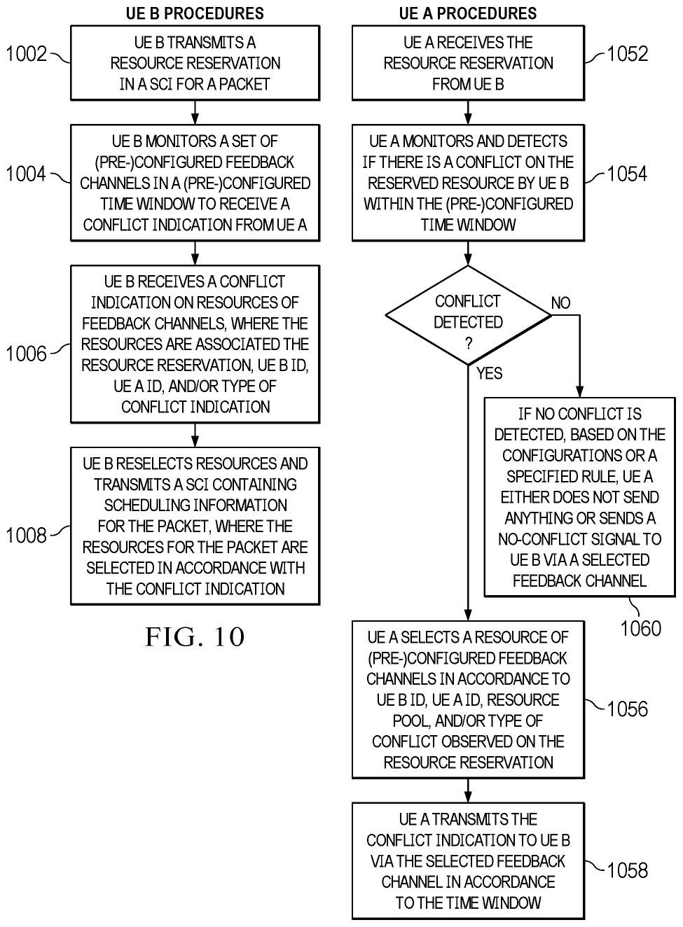

Based on the above described embodiments, the procedures of UE B and UE A of the inter-UE coordination via a feedback channel may be summarized in FIG. 10. In this disclosure, unless otherwise specified, UE A denotes the coordinating UE (e.g., UE A in FIGS. 6A-6C, or UE D in FIG. 6B), and UE B denotes the transmitting UE (e.g., UE B in FIGS. 6A-6C, or UE C in FIG. 6B). As shown in FIG. 10, on the UE B side, UE B may transmit a resource reservation in an SCI for a packet at operation 1002. At operation 1004, UE B may monitor a set of (pre-)configured feedback channels in a (pre-)configured time window to receive a conflict indication from UE A. At operation 1006, UE B may receive a conflict indication on resources of feedback channels. The resources may be associated the resource reservation, UE B ID, UE A ID, and/or the type of conflict indication. At operation 1008, UE B may reselect resources and transmit a SCI containing scheduling information for the packet, and the resources for the packet may be selected in accordance with the conflict indication.

On the UE A side, at operation 1052, UE A may receive the resource reservation in the SCI from UE B. At operation 1054, UE A may monitor and detect if there is a conflict on the reserved resource indicated in the resource reservation from UE B within the (pre-)configured time window. If conflict is detected, at operation 1056, UE A may select a resource of (pre-)configured feedback channels in accordance to UE B ID, UE A ID, resource pool, and/or the type of conflict observed on the resource reservation. At operation 1058, UE A may transmit the conflict indication to UE B via the selected feedback channel in accordance to the time window. If no conflict is detected, at operation 1060, based on the configurations or a specified rule, UE A either does not send anything or may send a no-conflict signal to UE B via a selected feedback channel.

For a detected conflict, UE A may send the coordination information such as conflict indication after the transmission of the scheduled PSSCH transmission. The same PSFCH associated with PSSCH transmission may be used for conflict indication if the PSFCH can be overloaded to carry more information. Embodiments of this disclosure provides the rule of the subchannel and slot, or PRB set for PSFCH for coordination information which may be one of following options.
The subchannel and slot for PSFCH for coordination information may be the same as that of PSFCH associated to the transmitted PSSCH.
The PRB set may be the same as that of PSFCH associated to the transmitted PSSCH.
The PRB set may be on different slots and/or different subchannels indicated by (pre-)configured timing offset parameters {S′₁, S′₂, . . . , S′_{Ms}} and/or frequency offset parameters (Δf₁, Δf₂, . . . , Δf_{Ms}} with the PSFCH associated to the transmitted PSSCH as the reference point (e.g., the original PSFCH associated to the transmitted PSSCH).
The location of slot, subchannel, or PRB set may be indicated by configuring one or more virtual PSSCHs where the virtual PSSCHs can be configured dynamically via SCI or timing offset values {S′₁, S′₂, . . . , S′_{Ms}} and/or frequency offset parameters (Δf₁, Δf₂, . . . , Δf_{Ms}} over a reference resource which can be the initial scheduled PSSCH.

Once the PSFCH PRB sets are decided, one or more PSFCHs can be selected in the PRB sets. As shown in FIG. 5B and the subsequent description, the index of the PSFCH in the PSFCH PRB sets can be determined by

j=(T_{ID}+R_{ID})mod L

L is the total number of resources in the PRB sets, T_{ID} is the layer 1 ID of transmit UE (i.e., the source ID in the 2^{nd} stage SCI), and R_{ID}=0 for unicast ACK/NACK feedback or groupcast option 1 NACK-only feedback.

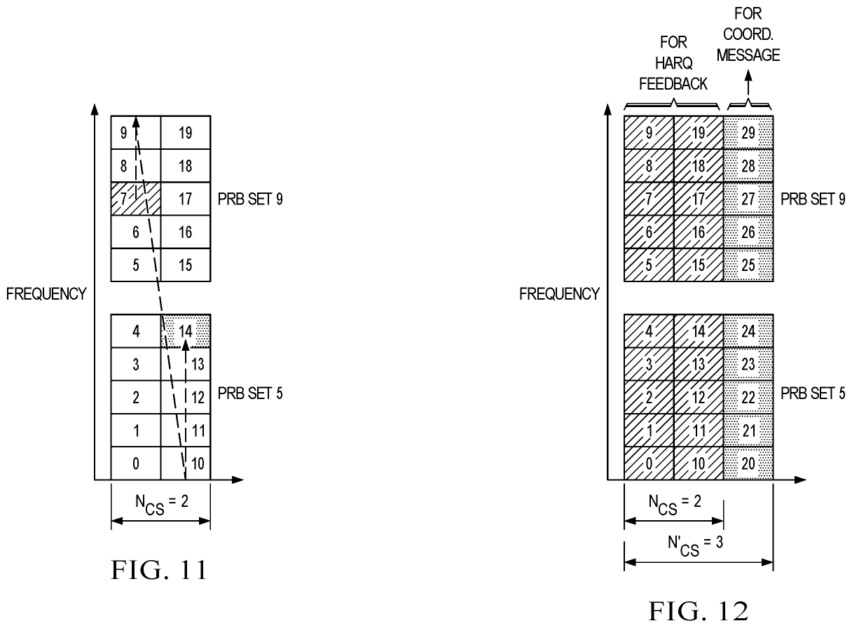

For expected/potential conflict, regardless how the subchannel/slot/PRB sets are determined as described above, the same rule as above can be reused to select the PSFCH once the PRB sets are determined. FIG. 11 illustrates PSFCH selection in two PSFCH PRB sets, according to some embodiments. In FIG. 11, Nsub=2, M_{S}=5 PRBs/Set. N_{CS}=2. PSFCH of index j=7 is selected if no change on the index. PSFCH of index j=14 is selected if an offset of Δ=7 is included. As shown in FIG. 11, PSFCH of index j=7 is selected for sending coordination information or conflict indicator. For expected/potential conflict, since the location of the PSFCH in a PRB set or PRB sets is related to transmit UE ID for unicast and groupcast option 1, if UE B does not send anything on the resources (e.g., viewed as a virtual PSSCH) that are associated with the same PSFCH PRB set, there is no explicit PSFCH collision. It is possible that there is a PSFCH collision with some other UEs. But such PSFCH collision is opportunistic as the index j is determined by transmit ID. Furthermore, the base sequence could be different for different UEs or sidelinks, the interference due to the collision is then dependent on the correlation between the two base sequences. However, if UE B occupies exact the same PSSCH resources as the virtual PSSCH for some other transmission for either unicast or groupcast with HARQ option-1 NACK only, the exact same PSFCH resource may selected if the same rule is reused. A PSFCH collision occurs.

Similarly, for detected conflict, there is a PSFCH allocated for HARQ feedback in unicast and groupcast transmissions. If there is no additional PSFCH in other slot/subchannel/PRB sets, again a collision occurs.

To solve such collision issue or mitigate the interference, one of the following options may be considered:
(1) use modified PSFCH format,
(2) use different PSFCH sequence,
(3) select different PSFCH in the same PRB sets.

Options (1) and (2) are related to the PSFCH format or definition that will be described below. In Option (3), a different PSFCH resource allocation is specified. An efficient way is to add an offset in the expression for PSFCH index j as

j=(T_{ID}+R_{ID}+Δ)mod L

The value of the offset Δ may be fixed, configured by higher layer, or signaled via physical layer signaling, e.g., SCI. As shown in FIG. 11, with Δ=7, PSFCH resource 14 is selected for the coordination message.

As described above, there could be some PSFCH collisions if some or all of the rules and principles defined in Release-16 are reused to allocate a PSFCH resource for sending the coordination information. Another approach is to partition the PSFCH resources into two pools, one for HARQ ACK/NACK and one for coordination information transmissions. Here, two types of PSFCH resource pool partitions are proposed as examples, i.e., the code domain partition and frequency domain partition.

For code domain partition, a general partition method may be that, for SL PSFCH, there are total L=N_{sub}*M_{S}*N_{CS} resources in the PRB sets for a PSSCH selection. A parameter L₁ may be specified to partition the resources into two PSFCH resource pools, one of size L₁ and one of size L−L₁. Without loss of generality, the first L PSFCH resources may be used for conventional HARQ feedback. The remaining L−L₁ PSFCH resources may be used for coordination message such as the conflict indication. However, such arbitrary partition could have an issue for legacy UE support, e.g., the legacy UE cannot be supported in the groupcast transmission from a Release-17 transmit UE with such new PSFCH resource partition.

For the partition method without impact on the legacy UE, it may be assumed that the PSFCH resource configuration for HARQ feedback is same as before. PSFCH for HARQ may be selected from L=N_{sub}*M_{S}*N_{CS} resources. For sending coordination message such as the conflict indication, a new value for the number of cyclic shift sets N′_{CS}>N_{CS} may be configured so that the PSFCH resource pool is expanded. Then, total number of PSFCH resources increases from L to L′=N_{sub}*M_{S}*N′_{CS}. Then additional L′−L resources can be used for allocating the PSFCH for coordination message. The legacy UE is not impacted because N_{CS} is known to it, and the PSFCH allocation is in the same pool as in Release-16.

FIG. 12 illustrates PSFCH resource partition in code domain, according to some embodiments. As shown in FIG. 12, N_{CS}=2 is originally configured for HARQ feedback with resources indexed with 0-19. Then, N′_{CS}=3 may be configured so that 10 more PSFCH resources (indexed with 20-29) are available for the coordination message.

To allocate the PSFCH for coordination message, the index j can be determined by the following equation.

j=L+((T_{ID}+R_{ID}+Δ)mod(L−L′).

The value of N′_{cs} may be arbitrarily selected from {2, . . . , 6}, as long as N′_{CS}>N_{CS}. To minimize the standard impact, the values specified in Release-16 (i.e., N′_{cs}∈{2, 3, 6}) may be reused so that the cyclic shift indexes for the new N_{CS} values do not need to be specified.

However, the proposed method above may not work for initially configured N_{CS}=6, as all resources are in the pool of PSFCHs for HARQ feedback.

For frequency domain partition, a general partition method may be to define M_{PRB}=N_{sub}*M_{S}. Then, there are total L=N_{sub}*M_{S}*N_{CS}=M_{PRB}*N_{CS} PSFCH resources in the PRB sets for a PSFCH selection. A parameter M_{PRB, 1} can be specified to partition the resources into two PSFCH resource pools in the frequency domain, one of size M_{PRB,1}*N_{CS} and one of size (M_{PRB}−M_{PRB,1})*N_{CS}. Part of the resource pool may be used for HARQ feedback and the other resource pool may be used for the coordination message such as the conflict indication. Again, such partition could have an issue to support legacy UEs.

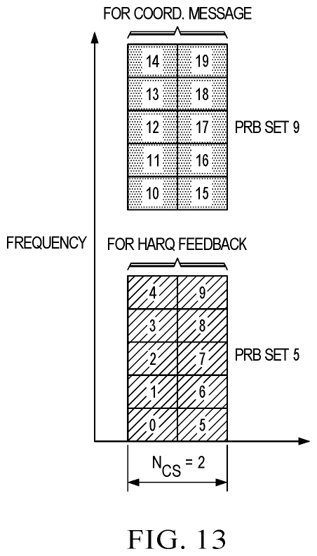

For partitioning without impact on the legacy UE, a method is provided herein that does not impact the legacy UE. As described above, when the PSSCH is allocated with resources on multiple subchannels, i.e., N_{sub}>1, multiple PRB sets on different subchannels may be used for PSFCH selection. However, an alternative option specified in Release-16 is that the PSFCH can be selected in one PRB set on the starting subchannel of PSSCH. Based on this feature, the resources for the cases N_{sub}>1 may be partitioned as shown in FIG. 13. FIG. 13 illustrates PSFCH resource partition in the frequency domain, according to some embodiments. A UE is configured with the PSFCH for HARQ feedback selected from one PRB set aligned with the starting subchannel of the PSSCH. Then, other PSFCH resources can be used for PSFCH allocations for sending the coordination information. The PSFCH channel index for coordination can be obtained by the following equation.

j=Mₛ*N_{CS}+((T_{ID}+R_{ID}+Δ)mod((N_{sub}−1)*Mₛ*N_{CS})

In the above equation, Δ can be set to 0 or some other value in conjunction with the presented method described before. As shown in FIG. 12, the PSFCH index j can be one from the {10, . . . , 19} in a PRB set.

For detected conflict using the PSFCH resources for the initially scheduled PSSCH, the disclosed technique works fine if N_{sub}>1. For both expected/potential and detected conflict, it may be achieved by specifying a virtual PSSCH with N_{sub}>1 regardless the subchannel size for the initially scheduled PSSCH.

For the modified PSFCH format with single state/1-bit feedback, for ACK/NACK feedback, the 1-bit information or the two states (ACK and NACK) may be represented by two cyclic shifts of the sequence. In the embodiment modified PSFCH format, one state, “Conflict” or “NACK-Conflict” state, may be added to indicate the conflict for either expected/potential or detected conflict.

Since the ACK/NACK messages are represented by different cyclic shifts of the same sequence, the new NACK-Conflict state may also represented by another conflict shift C₁, which is different from the ones for ACK/NACK, as shown in Table 1, C₁≠0, or 6. On the other hand, the value of C₁ may be chosen to avoid the conflict with other PSFCHs on the same PRB resource represented by different cyclic shifts if same base sequence is used.

Since the length of sequence is 12, the total number of cyclic shifts is 12, including the 0 shift. As shown in Table 16.3-1 of TS38.213, when N_{CS}=6, all 12 cyclic shifts are used for ACK/NACK transmissions. No additional cyclic shifts can be used to indicate the conflict. However, for N_{CS}=1, 2, 3, some cyclic shifts that were not used can be used to represent the NACK-Conflict state. The C₁ value may be specified for each N_{CS} configuration. By examining the cyclic shift indexes in Table 16.3-1 of TS38.213 in existing table, one C₁ value from {1, 5, 7, 11} for all three N_{CS} configurations can be chosen/selected.

TABLE 1
Modified PSFCH Mapping of HARQ ACK/NACK
with Conflict indication

| HARQ-ACK Value | 0 (NACK) | 1 (ACK) | 2 (NACK-Conflict) |
|---|---|---|---|
| Sequence cyclic shift | 0 | 6 | C₁ |

Similarly, for HARQ option 1 with NACK only, one more state can also be added as shown in Table 2 with a cyclic shift C₂.

TABLE 2
Modified PSFCH Mapping of HARQ NACK-
Only with Conflict indication

| HARQ-ACK Value | 0 (NACK) | 1 (ACK) | 2 (NACK-Conflict) |
|---|---|---|---|
| Sequence cyclic shift | 0 | N/A | C₂ |

When using the modified PSFCH format for the detected conflict indication, the same PSFCH resource allocation without any changes may be reused. UE B can detect the PSFCH to know if there is a conflict. Furthermore, if the modified PSFCH is used, it is possible that the triggering of inter-UE coordination may be omitted as a UE can always detect the PSFCH based on the modified PSFCH format for the introduced NACK-Conflict. However, this embodiment may increase the complexity unnecessarily for the UEs that do not need the coordination.

For PSFCH channel allocation, instead of changing the PSFCH format, a PSFCH may be allocated using the same HARQ ACK/NACK mapping format for conflict indication or, in general, transmitting the coordination information. To carry one-bit information, one PSFCH channel allocation is needed. One of the states, ACK or NACK, may be used for conflict indication. The PSFCH channel allocation for coordination information is described in this disclosure for expected/potential conflict or detected conflict.

For modified PSFCH format with multi-state/multi-bit feedback, note that for modified ACK/NACK after adding one cyclic shift for NACK-conflict state as in Table 1, the 9, 6, and 3 cyclic indexes are still unused for N_{CS}=1, 2, and 3, respectively. More states may be added in the table to carry more information. For N_{CS}=1, 2, and 3, additional 9, 3, and 1 state can be added. As an example shown in Table 3, more states (additional state 1, 2, 3, . . . ) may be included in the table including one for the conflict indication. Each state is represented with one cyclic shift. Besides the conflict indication, the additional information such as conflict type described in this disclosure may be included in the feedback.

TABLE 3
Modified PSFCH Mapping of HARQ ACK/NACK
with Conflict Indication

| | | | 2 (state | | | |
|---|---|---|---|---|---|---|
| HARQ- | 0 | 1 | 1: NACK- | 3 (State | 4 (State | |
| ACK Value | (NACK) | (ACK) | Conflict) | 2) | 3) | . . . |
| Sequence | 0 | 6 | C_{1, 1} | C_{1, 2} | C_{1, 3} | . . . |
| cyclic shift | | | | | | |

Similarly, for the HARQ NACK only PSFCH, Table 2 may be expanded by adding more states in the PSFCH format as shown in Table 4 below.

TABLE 4
Modified PSFCH Mapping of HARQ NACK-
Only with Conflict Indication

| | | | 2 (state | | | |
|---|---|---|---|---|---|---|
| HARQ- | 0 | 1 | 1: NACK- | 3 (State | 4 (State | |
| ACK Value | (NACK) | (ACK) | Conflict) | 2) | 3) | . . . |
| Sequence | 0 | N/A | C_{2, 1} | C_{2, 2} | C_{3, 3} | . . . |
| cyclic shift | | | | | | |

For PSFCH channel allocations, the same PSFCH format carrying 1 bit/two states information in each PSFCH may be used to send the coordination information. For multi-bit feedback, more than PSFCHs are allocated as described in this disclosure.

For PSFCH channel allocation with modified PSFCH format, if a dedicated PSFCH is allocated for coordination, as described in this disclosure, the information mapping of PSFCH may be redefined to carry the coordination information including conflict indication. As shown in Table 5, a 2-bit/4-states mapping table may be provided, and each state may be represented with a cyclic shift. Without loss of generality, State 1 may be for the conflict indication.

TABLE 5
Modified PSFCH Mapping of Coordination
Information (2 bits/4 states)

| | State 1 | | | |
|---|---|---|---|---|
| | (NACK- | | | |
| State Value | Conflict) | State 2 | State 3 | State 4 |
| Bit values | (b₁, b₂) = | (b₁, b₂) = | (b₁, b₂) = | (b₁, b₂) = |
| | (0, 0) | (1, 0) | (0, 1) | (1, 1) |
| Sequence cyclic | C_{3, 1} | C_{3, 2} | C_{3, 3} | C_{3, 4} |
| shift | | | | |

As shown here, the PSFCH channel allocation for 1-bit message for conflict indication is a special case of this approach. The mapping of ACK/NACK can be reused to represent state 1 and 2 for carrying a certain coordination information (e.g., the conflict indication).

For PSFCH sequence configuration, both the message carried in PSFCH and the PSFCH reuse may be achieved with different cyclic shifts of a base sequence. There are total 30 base sequences of length 12 specified in NR. Either the same first base sequence with configuration of u=0 is used or the base sequence of u=n_{ID} mod 30 is used, where n_{ID} is configured via upper layer parameter sl-PSFCH-HopID. So, for the PSFCH or PSFCH-like channel for coordination message, another sl-PSFCH-HopID can be configured, which can be named as sl-PSFCH-HopID-Coord. The new sl-PSFCH-HopID-Coord can be individually configured in upper layer, or specified with an offset on the original sl-PSFCH-HopID configured for HARQ feedback (i.e., sl-PSFCH-HopID-Coord=sl-PSFCH-HopID+Δ_{HopID}). The value of +Δ_{HopID} can be a fixed value or configured in the upper layer.

The conflict indication which is carried with 1-bit information or just one state in the container for coordination information is described above. Also as described above, more coordination information can be carried with PSFCH or PSFCH-like channels.

The conflict type indication included in the coordination information may help UE B to avoid further conflict in the resource reselection. Among all conflict types, the conflict due to half-duplex may be an example of information for resource reselection for the case of expected/potential conflict. For half-duplex issue, the entire slot where UE A or the receive UE of UE B's scheduled PSSCH may be excluded from resource reselection. If such conflict type is not known at UE B, when UE B performs resource reselection after receiving the conflict indication, UE B may select a resource on the same slot as that for the initially reserved resource, resulting in a new conflict. Therefore, it may be better to include the indication of half-duplex conflict in coordination information using the methods for multi-state/multi-bit feedback described above.

In addition, the slots scheduled for UE A's transmission may be included in the coordination message sent to UE B.

When a PSSCH is scheduled with resources on multiple subchannels, not every subchannel will have a conflict, unless it is a half-duplex conflict. Then, indicating the subchannels where conflicts are detected may avoid unnecessary resource reselection. The subchannels without conflict may still be used for PSSCH transmission. A new SCI may be sent to reserve these subchannels with new modulation and coding scheme, etc. Additional information for per subchannel conflict indication may be sent using the methods for multi-state/multi-bit feedback described above.

When the PSFCH or PSFCH-like channel is used for sending conflict indication or other coordination information, it is possible that there is a conflict due to simultaneous transmission and/or reception of PSFCH on the same slot. Such conflict also happens for the PSFCH for HARQ feedback. In Release-16, to resolve this conflict, the UE transmits HARQ feedback based on the priority order of data sent in the PSSCH. To solve the conflict with the PSFCH or PSFCH like channel for coordination, the embodiment techniques may assign a priority value of the PSFCH or PSFCH-like channel carrying the coordination information with one of the following options:
assign the same priority as the priority associated with the scheduled PSSCH or transmitted PSSCH,
assign a new priority on the PSFCH that can be semi-statically configured by the higher layer or signaled in the SCI for the original PSSCH.

Other than the PSFCH or PSFCH-like channel, the coordination information may be delivered via a MAC-CE. The MAC-CE may be sent on the PSSCH. The message size or amount of information bits carried in the MAC-CE is much larger than the PHY signals. More information can be transmitted to UE B. Besides conflict indication, the additional information described in this disclosure can be easily carried in the MAC-CE.

For example, for per-subchannel conflict indications, a bit-map on the subchannel conflicts may be included int the MAC-CE.

However, since the MAC-CE is transmitted in PSSCH, additional sensing, PSSCH resource selection, and transmissions may be needed, which may also experience some conflict.

Besides the conflict indication, UE A may also send the preferred resource set and/or non-preferred resource sets to UE B in the MAC_CE for UE B's resource reselection, (i.e., both scheme 1 and 2). UE A may also select a resource and signal the resource via the MAC CE to UE B. Based on configuration or attributes of UE A and B (e.g., platoon leader and trailing truck in the truck platoon scenario), or UE B's behavior or usage of the coordination information (e.g., completely following UE A's coordination information), UE B may then use it as the resource reservation for the packet transmissions. In this case, it is more like that UE B uses the UE A's sidelink grant for the transmissions and UE A performs the re-evaluation/pre-emption for UE B after UE B selects a resource.

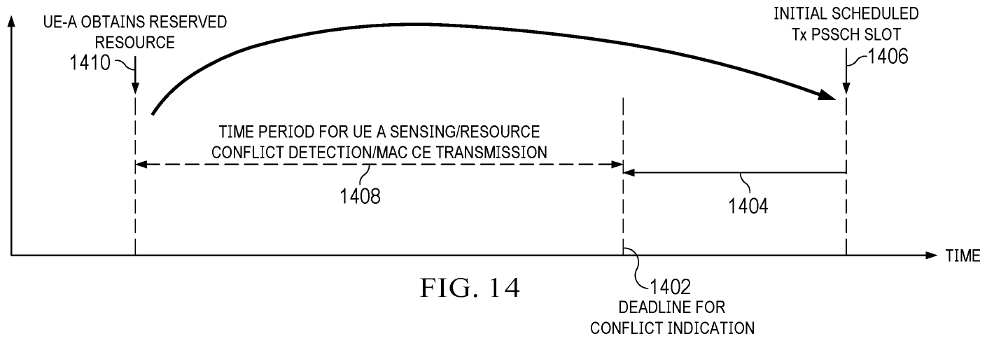

Since transmission of a MAC-CE, in general, has a larger latency than a PHY signal, a timing requirement may need to be specified. FIG. 14 illustrates example coordination information in the MAC-CE, according to some embodiments. As shown in FIG. 14, a deadline 1402 for conflict indication and other coordination information sent in MAC-CE may be specified by a timing advance slot offset 1404 from the initial scheduled transmit PSSCH slot 1406 for expected/potential conflicts as the deadline for sending the MAC-CE. For detected conflict, a maximum delay 1408 after transmitting the scheduled PSSCH 1410 may be specified so that the conflict indication can be received in time. Such maximum delay may be specified as the packet delay budget for transmitting the coordination information.

Alternatively, the deadline may be specified by a latency bound (i.e., maximum delay S_{LB} after UE B sends the SCI with the selected resources for PSSCH). Such latency bound can be signaled from UE B to UE A (e.g., through PC₅-RRC). Assuming UE B sends the SCI on t₀, UE A then sends the coordination information including the conflict indication before the latency bound (i.e., t₀+S_{LB}), which may be configured by the higher layer or signaled by UE B in the PHY via SCI (e.g., the same SCI sent for the resource reservation).

For joint PSFCH and MAC CE for coordination information, note that the PFSCH and the MAC CE may be both used for the coordination information in the same UE B's resource selection process. In general, when PSFCH and MAC CE are used together for coordination for the same UE B resource selection process, the coordination information may be split and carried by PSFCH and MAC CE separately. The SCI sent by UE B for resource reservation may be used for supporting the coordination feedback.

For example, the PSFCH can be used for conflict indication as well as an indication that a MAC CE carrying additional coordination information for the same UE B resource selection process. The coordination information can be conflict type, preferred resource set, non-preferred resource set, or a preferred resource set as a sidelink grant for the case of UE B's resource(s) to be used for its transmission resource (re)-selection is based only on the received coordination information.

Similar to MAC CE, the coordination information may be sent via the PHY signal SCI, including conflict indication and/or preferred resource set or non-preferred resource set. A maximum delay or latency bound may be specified for the coordination information carried by SCI from UE A to UE B, which may be configured at the higher layer. Such latency bound can be signaled from UE B to UE A (e.g., through PC₅-RRC). After UE B sends the SCI on t₀, UE A may then send the coordination information including the conflict indication before the configured latency bound (e.g., t₀+S_{LB}), which may be configured by the higher layer or signaled by UE B in the PHY via the SCI (e.g., the same SCI sent for the resource reservation).

Besides the conflict indication, UE A may also send the preferred resource set and/or non-preferred resource sets to UE B using the SCI for UE B's resource reselection (i.e., both schemes 1 and 2). UE A may also select a resource and signal the resource via the SCI to UE B. Based on configuration or attributes of UE A and UE B, or UE B's behavior or usage of the coordination information, UE B's resource to be used for its transmission resource (re)-selection may be based only on the received coordination information, the SCI for coordination feedback from UE A to UE B may carry the selected resource as a preferred resource set for UE B. UE B may then use it as the resource reservation for the packet transmissions. In this case, UE A uses the SCI as the coordination information feedback that includes the reserved resource as a SL grant to UE B so that UE B may use the UE A's resource reservation for the transmissions. It may be viewed as UE A performing the re-evaluation/pre-emption for UE B after UE B selects a resource.

Although with the modified PSFCH format, it may be unnecessary to trigger or configure inter-UE coordination because the conflict indication carried in the modified PSFCH may act as implicit coordination triggering. However, with explicit triggering or higher layer configured, a configured UE B may expect some coordination information to be sent from UE A. The coordination may be triggered via one of following options.
UE B may trigger the coordination explicitly with a SCI signal (e.g., by using the SCI format 1 reserved bit). SCI sent by UE B for initial resource reservation may be used for supporting the coordination feedback including triggering and/or indication/activation of one or more of the following coordination feedback, such as PSFCH, MAC CE, PSFCH+MAC CE, SCI, PSFCH+MAC CE, etc.
Inter-UE coordination may be determined by the higher layer configuration (e.g., activate/deactivate without explicit triggering).
Coordination may be triggered and started by UE A when certain condition is met.

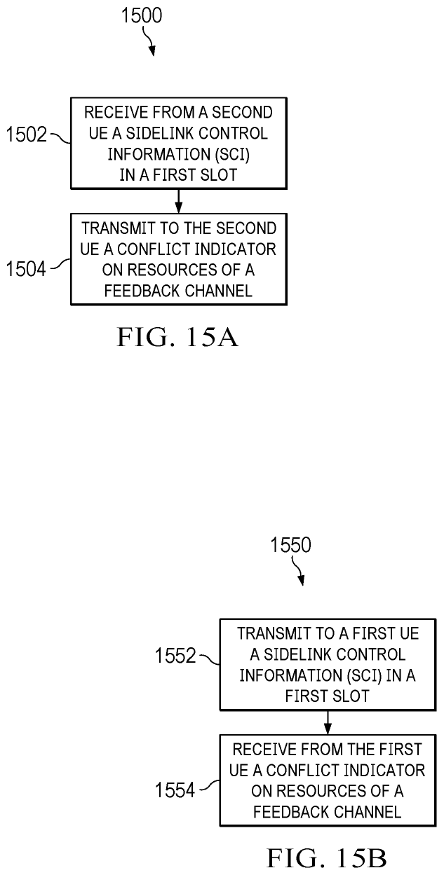

FIG. 15A illustrates a flow chart of a method 1500 for inter-UE coordination in SL communications, according to some embodiments. The method 1500 may be carried out or performed by a first UE (e.g., UE A). The method 1500 may also be carried out or performed by routines, subroutines, or modules of software executed by one or more processing units. The method 1500 may further be carried out or performed by hardware, software, or a combination of hardware and software. Coding of the software for carrying out or performing the method 1500 is well within the scope of a person of ordinary skill in the art having regard to the present disclosure. The method 1500 may include additional or fewer operations than those shown and described and may be carried out or performed in a different order. Computer-readable code or instructions of the software executable by the one or more processing units may be stored on a non-transitory computer-readable medium, such as for example, the memory of the first UE.

The method 1500 starts at operation 1502, where the first UE (e.g., UE A) receives from a second UE (e.g., UE B) a sidelink control information (SCI) in a first slot. The SCI comprises a resource reservation for a shared channel. The resource reservation indicates a set of frequency resources and a time resource assignment. At operation 1504, the first UE transmits to the second UE a conflict indicator on resources of a feedback channel. The resources of the feedback channel include a second slot for transmitting the conflict indicator. A location of the second slot is based on one of the first slot or a slot indicated by the time resource assignment. The conflict indicator indicates a potential resource conflict or a detected resource conflict on at least one of the set of frequency resources or the time resource assignment indicated by the resource reservation.

In some embodiments, the conflict indicator may indicate the potential resource conflict on the time resource assignment based on sensing or the detected resource conflict on the time resource assignment, or the conflict indicator may indicate the potential resource conflict on the set of frequency resources based on sensing or the detected resource conflict on set of frequency resources. In some embodiments, the location of the second slot may be after and closest to the first slot plus a time gap. In some embodiments, the location of the second slot may be a minimum time before the slot indicated by the time resource assignment. In some embodiments, the location of the second slot based on one of the first slot or the slot indicated by the time resource assignment may be configured by a base station or predefined. In some embodiments, the first UE may be a destination of a transmission of the shared channel from the second UE. In some embodiments, the feedback channel may be a physical sidelink feedback channel (PFSCH). In some embodiments, enablement of transmission of the conflict indicator may be configured by higher layer signaling. In some embodiments, the SCI may further include one-bit information indicating that the second UE can receive the conflict indicator from the first UE. In some embodiments, the SCI may include a fewer number of reserved bits when the second UE is configured to transmit the one-bit information. In some embodiments, the first UE may monitor the set of frequency resources indicated by the time resource assignment in the SCI. In some embodiments, the feedback channel may include a first set of resources and a second set of resources. The first set of resources may carry acknowledgements (ACKs) or negative ACKs (NACKs) for reception of shared channels, and the second set of resources may include the resources of the feedback channel carrying the conflict indicator. In some embodiments, the first set of resources and the second set of resources may be located on different frequency resources. In some embodiments, the first UE may transmit the conflict indicator to the second UE in accordance to a priority indicated in the SCI.

FIG. 15B illustrates a flow chart of a method 1550 for inter-UE coordination in SL communications, according to some embodiments. The method 1550 may be carried out or performed by a second UE (e.g., UE B). The method 1550 may also be carried out or performed by routines, subroutines, or modules of software executed by one or more processing units. The method 1550 may further be carried out or performed by hardware, software, or a combination of hardware and software. Coding of the software for carrying out or performing the method 1550 is well within the scope of a person of ordinary skill in the art having regard to the present disclosure. The method 1550 may include additional or fewer operations than those shown and described and may be carried out or performed in a different order. Computer-readable code or instructions of the software executable by the one or more processing units may be stored on a non-transitory computer-readable medium, such as for example, the memory of the second UE.

The method 1550 starts at operation 1552, where the second UE (e.g., UE B) transmits to a first UE (e.g., UE A) a sidelink control information (SCI) in a first slot. The resource reservation indicates a set of frequency resources and a time resource assignment. At operation 1554, the second UE receives from the first UE a conflict indicator on resources of a feedback channel. The resources of the feedback channel include a second slot for receiving the conflict indicator. A location of the second slot is based on one of the first slot or a slot indicated by the time resource assignment. The conflict indicator indicates a potential resource conflict or a detected resource conflict on at least one of the set of frequency resources or the time resource assignment indicated by the resource reservation.

In some embodiments, the conflict indicator may indicate the potential resource conflict on the time resource assignment based on sensing or the detected resource conflict on the time resource assignment or the conflict indicator may indicate the potential resource conflict on the set of frequency resources based on sensing or the detected resource conflict on set of frequency resources. In some embodiments, the location of the second slot may be after and closest to the first slot plus a time gap. In some embodiments, the location of the second slot may be a minimum time before the slot indicated by the time resource assignment. In some embodiments, the location of the second slot based on one of the first slot or the slot indicated by the time resource assignment may be configured by a base station or predefined. In some embodiments, the first UE may be a destination of a transmission of the shared channel from the second UE. In some embodiments, the feedback channel may be a physical sidelink feedback channel (PFSCH). In some embodiments, enablement of reception of the conflict indicator may be configured by higher layer signaling. In some embodiments, the SCI may further include one-bit information indicating that the second UE can receive the conflict indicator from the first UE. In some embodiments, the SCI may include a fewer number of reserved bits when the second UE is configured to transmit the one-bit information. In some embodiments, the feedback channel includes a first set of resources and a second set of resources, wherein the first set of resources may carry acknowledgements (ACKs) or negative ACKs (NACKs) for reception of shared channels, and the second set of resources may include the resources of the feedback channel carrying the conflict indicator. In some embodiments, the first set of resources and the second set of resources may be located on different frequency resources. In some embodiments, the second UE may receive the conflict indicator from the first UE in accordance to a priority indicated in the SCI.

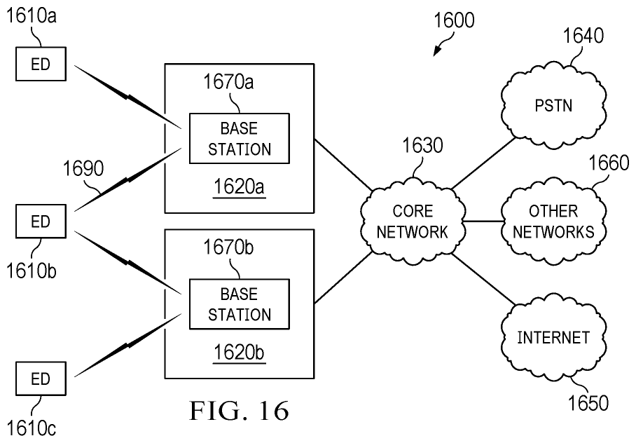

FIG. 16 is a diagram of an example communication system 1600. In general, the system 1600 enables multiple wireless or wired users to transmit and receive data and other content. The system 1600 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1600 includes electronic devices (ED) 1610a-1610c, radio access networks (RANs) 1620a-1620b, a core network 1630, a public switched telephone network (PSTN) 1640, the Internet 1650, and other networks 1660. While certain numbers of these components or elements are shown in FIG. 16, any number of these components or elements may be included in the system 1600.

The EDs 1610a-1610c are configured to operate or communicate in the system 1600. For example, the EDs 1610a-1610c are configured to transmit or receive via wireless or wired communication channels. Each ED 1610a-1610c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1620a-1620b here include base stations 1670a-1670b, respectively. Each base station 1670a-1670b is configured to wirelessly interface with one or more of the EDs 1610a-1610c to enable access to the core network 1630, the PSTN 1640, the Internet 1650, or the other networks 1660. For example, the base stations 1670a-1670b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1610a-1610c are configured to interface and communicate with the Internet 1650 and may access the core network 1630, the PSTN 1640, or the other networks 1660.

In the embodiment shown in FIG. 16, the base station 1670a forms part of the RAN 1620a, which may include other base stations, elements, or devices. Also, the base station 1670b forms part of the RAN 1620b, which may include other base stations, elements, or devices. Each base station 1670a-1670b operates to transmit or receive wireless signals within a particular geographic region or area, sometimes referred to as a “cell.” In some embodiments, multiple-input multiple-output (MIMO) technology may be employed having multiple transceivers for each cell.

The base stations 1670a-1670b communicate with one or more of the EDs 1610a-1610c over one or more air interfaces 1690 using wireless communication links. The air interfaces 1690 may utilize any suitable radio access technology.

It is contemplated that the system 1600 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1620a-1620b are in communication with the core network 1630 to provide the EDs 1610a-1610c with voice, data, application, Voice over Internet Protocol (VoIP), or other services. Understandably, the RANs 1620a-1620b or the core network 1630 may be in direct or indirect communication with one or more other RANs (not shown). The core network 1630 may also serve as a gateway access for other networks (such as the PSTN 1640, the Internet 1650, and the other networks 1660). In addition, some or all of the EDs 1610a-1610c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1650.

Although FIG. 16 illustrates one example of a communication system, various changes may be made to FIG. 16. For example, the communication system 1600 could include any number of EDs, base stations, networks, or other components in any suitable configuration.

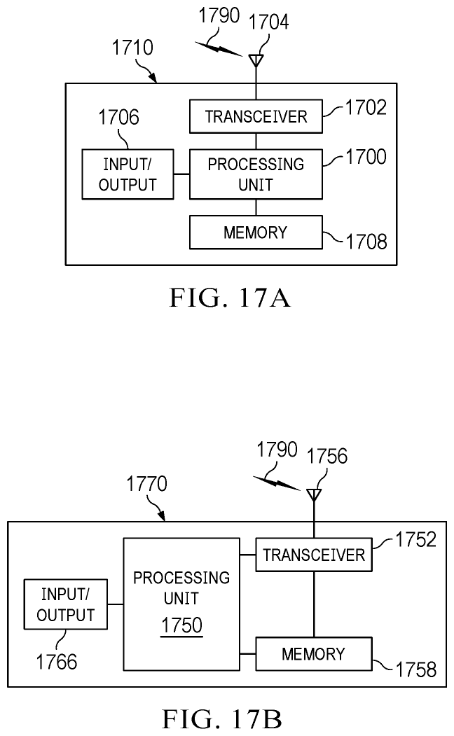

FIGS. 17A and 17B illustrate example devices that may implement the methods and teachings according to this disclosure. In particular, FIG. 17A illustrates an example end device (ED) or a terminal device 1710, and FIG. 17B illustrates an example base station 1770. These components could be used in the system 1600 or in any other suitable system.

As shown in FIG. 17A, the ED 1710 includes at least one processing unit 1700. The processing unit 1700 implements various processing operations of the ED 1710. For example, the processing unit 1700 could perform signal coding, data processing, power control, input/output processing, or any other functionality enabling the ED 1710 to operate in the system 1600. The processing unit 1700 also supports the methods and teachings described in more detail above. Each processing unit 1700 includes any suitable processing or computing device configured to perform one or more operations. Each processing unit 1700 could, for example, include a microprocessor, microcontroller, digital signal processor, field programmable gate array, or application specific integrated circuit.

The ED 1710 also includes at least one transceiver 1702. The transceiver 1702 is configured to modulate data or other content for transmission by at least one antenna or NIC (Network Interface Controller) 1704. The transceiver 1702 is also configured to demodulate data or other content received by the at least one antenna 1704. Each transceiver 1702 includes any suitable structure for generating signals for wireless or wired transmission or processing signals received wirelessly or by wire. Each antenna 1704 includes any suitable structure for transmitting or receiving wireless or wired signals 1790. One or multiple transceivers 1702 could be used in the ED 1710, and one or multiple antennas 1704 could be used in the ED 1710. Although shown as a single functional unit, a transceiver 1702 could also be implemented using at least one transmitter and at least one separate receiver.

The ED 1710 further includes one or more input/output devices 1706 or interfaces (such as a wired interface to the Internet 1650). The input/output devices 1706 facilitate interaction with a user or other devices (network communications) in the network. Each input/output device 1706 includes any suitable structure for providing information to or receiving information from a user, such as a speaker, microphone, keypad, keyboard, display, or touch screen, including network interface communications.

In addition, the ED 1710 includes at least one memory 1708. The memory 1708 stores instructions and data used, generated, or collected by the ED 1710. For example, the memory 1708 could store software or firmware instructions executed by the processing unit(s) 1700 and data used to implement the embodiment methods. Each memory 1708 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 17B, the base station 1770 includes at least one processing unit 1750, at least one transceiver 1752, which includes functionality for a transmitter and a receiver, one or more antennas 1756, at least one memory 1758, and one or more input/output devices or interfaces 1766. A scheduler, which would be understood by one skilled in the art, is coupled to the processing unit 1750. The scheduler could be included within or operated separately from the base station 1770. The processing unit 1750 implements various processing operations of the base station 1770, such as signal coding, data processing, power control, input/output processing, or any other functionality. The processing unit 1750 can also support the methods and teachings described in more detail above. Each processing unit 1750 includes any suitable processing or computing device configured to perform one or more operations. Each processing unit 1750 could, for example, include a microprocessor, microcontroller, digital signal processor, field programmable gate array, or application specific integrated circuit.

Each transceiver 1752 includes any suitable structure for generating signals for wireless or wired transmission to one or more EDs or other devices. Each transceiver 1752 further includes any suitable structure for processing signals received wirelessly or by wire from one or more EDs or other devices. Although shown combined as a transceiver 1752, a transmitter and a receiver could be separate components. Each antenna 1756 includes any suitable structure for transmitting or receiving wireless or wired signals 1790. While a common antenna 1756 is shown here as being coupled to the transceiver 1752, one or more antennas 1756 could be coupled to the transceiver(s) 1752, allowing separate antennas 1756 to be coupled to the transmitter and the receiver if equipped as separate components. Each memory 1758 includes any suitable volatile or non-volatile storage and retrieval device(s). Each input/output device 1766 facilitates interaction with a user or other devices (network communications) in the network. Each input/output device 1766 includes any suitable structure for providing information to or receiving/providing information from a user, including network interface communications.

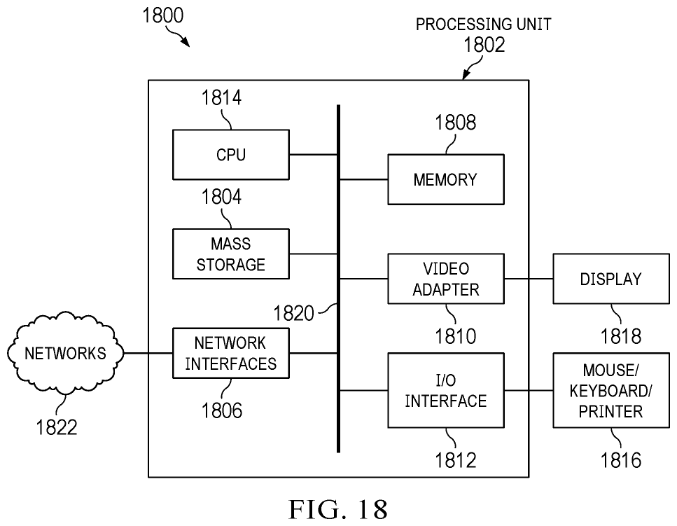

FIG. 18 is a block diagram of a computing system 1800 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1800 includes a processing unit 1802. The processing unit includes a central processing unit (CPU) 1814, memory 1808, and may further include a mass storage device 1804, a video adapter 1810, and an I/O interface 1812 connected to a bus 1820.

The bus 1820 may be one or more of any type of several bus architectures including a memory bus or memory controller, a peripheral bus, or a video bus. The CPU 1814 may comprise any type of electronic data processor. The memory 1808 may comprise any type of non-transitory system memory such as static random access memory (SRAM), dynamic random access memory (DRAM), synchronous DRAM (SDRAM), read-only memory (ROM), or a combination thereof. In an embodiment, the memory 1808 may include ROM for use at boot-up, and DRAM for program and data storage for use while executing programs. The memory 1808 may include instructions executable by the processing unit 1802.

The mass storage 1804 may comprise any type of non-transitory storage device configured to store data, programs, and other information and to make the data, programs, and other information accessible via the bus 1820. The mass storage 1804 may comprise, for example, one or more of a solid state drive, hard disk drive, a magnetic disk drive, or an optical disk drive.

The video adapter 1810 and the I/O interface 1812 provide interfaces to couple external input and output devices to the processing unit 1802. As illustrated, examples of input and output devices include a display 1818 coupled to the video adapter 1810 and a mouse, keyboard, or printer 1816 coupled to the I/O interface 1812. Other devices may be coupled to the processing unit 1802, and additional or fewer interface cards may be utilized. For example, a serial interface such as Universal Serial Bus (USB) (not shown) may be used to provide an interface for an external device.

The processing unit 1802 also includes one or more network interfaces 1806, which may comprise wired links, such as an Ethernet cable, or wireless links to access nodes or different networks. The network interfaces 1806 allow the processing unit 1802 to communicate with remote units via the networks. For example, the network interfaces 1806 may provide wireless communication via one or more transmitters/transmit antennas and one or more receivers/receive antennas. In an embodiment, the processing unit 1802 is coupled to a local-area network 1822 or a wide-area network for data processing and communications with remote devices, such as other processing units, the Internet, or remote storage facilities.

In some embodiments, the computing system 1800 may comprise an apparatus configured to implement the embodiments of the present disclosure. The processing units 1802 may execute the instructions stored in the memory 1808 to cause the apparatus to perform the embodiment methods of the present disclosure.

All or some of the foregoing embodiments may be implemented by software, hardware, firmware, or any combination thereof. When software is used for implementation, the embodiments may be implemented completely or partially in a form of a computer program product. The computer program product includes one or more computer instructions. When the computer program instruction is loaded and executed on a computer, all or some of the procedures or functions are generated according to the embodiments of the present disclosure. The computer may be a general-purpose computer, a special-purpose computer, a computer network, or another programmable apparatus. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line) or wireless (for example, infrared, microwave, or the like) manner. The computer-readable non-transitory media includes all types of computer readable media, including magnetic storage media, optical storage media, flash media or solid state storage media.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a determining unit/module, an obtaining unit/module, an priority updating unit/module, an indicating unit/module, a resource selecting unit/module, a resource pool partitioning unit/module, a re-evaluating unit/module, a pre-emption unit/module, a resource reserving unit/module, and/or a priority mapping unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
receiving, by a first user equipment (UE) from a second UE, a sidelink control information (SCI) in a first slot, the SCI comprising a resource reservation for a shared channel, wherein the resource reservation indicates a set of frequency resources and a time resource assignment; and
transmitting, by the first UE to the second UE, a conflict indicator on resources of a feedback channel,
wherein the resources of the feedback channel include a second slot for transmitting the conflict indicator, a location of the second slot based on one of the first slot or a slot indicated by the time resource assignment, and
wherein the conflict indicator indicates a potential resource conflict or a detected resource conflict on at least one of the set of frequency resources or the time resource assignment indicated by the resource reservation.

2. The method of claim 1,
wherein the conflict indicator indicates the potential resource conflict on the time resource assignment based on sensing or the detected resource conflict on the time resource assignment, or
wherein the conflict indicator indicates the potential resource conflict on the set of frequency resources based on sensing or the detected resource conflict on set of frequency resources.

3. The method of claim 1, wherein the location of the second slot is after and closest to the first slot plus a time gap.

4. The method of claim 1, wherein the location of the second slot is a minimum time before the slot indicated by the time resource assignment.

5. The method of claim 1, wherein the location of the second slot based on one of the first slot or the slot indicated by the time resource assignment is configured by a base station or predefined.

6. The method of claim 1, wherein the first UE is a destination of a transmission of the shared channel from the second UE.

7. The method of claim 1, wherein the feedback channel is a physical sidelink feedback channel (PFSCH).

8. The method of claim 1, wherein enablement of transmission of the conflict indicator is configured by higher layer signaling.

9. The method of claim 1, the SCI further including one-bit information indicating that the second UE can receive the conflict indicator from the first UE.

10. The method of claim 9, wherein the SCI includes a fewer number of reserved bits when the second UE is configured to transmit the one-bit information.

11. The method of claim 9, wherein the first UE monitors the set of frequency resources indicated by the time resource assignment in the SCI.

12. The method of claim 1, wherein the feedback channel includes a first set of resources and a second set of resources, wherein the first set of resources carries acknowledgements (ACKs) or negative ACKs (NACKs) for reception of shared channels, and wherein the second set of resources includes the resources of the feedback channel carrying the conflict indicator.

13. The method of claim 12, wherein the first set of resources and the second set of resources are located on different frequency resources.

14. The method of claim 1, the transmitting the conflict indicator comprising:
transmitting, by the first UE to the second UE, the conflict indicator in accordance to a priority indicated in the SCI.

15. A method, comprising:
transmitting, by a second user equipment (UE) to a first UE, a sidelink control information (SCI) in a first slot, the SCI comprising a resource reservation for a shared channel, wherein the resource reservation indicates a set of frequency resources and a time resource assignment; and
receiving, by the second UE from the first UE, a conflict indicator on resources of a feedback channel,
wherein the resources of the feedback channel include a second slot for receiving the conflict indicator, a location of the second slot based on one of the first slot or a slot indicated by the time resource assignment, and
wherein the conflict indicator indicates a potential resource conflict or a detected resource conflict on at least one of the set of frequency resources or the time resource assignment indicated by the resource reservation.

16. The method of claim 15,
wherein the conflict indicator indicates the potential resource conflict on the time resource assignment based on sensing or the detected resource conflict on the time resource assignment, or
wherein the conflict indicator indicates the potential resource conflict on the set of frequency resources based on sensing or the detected resource conflict on set of frequency resources.

17. The method of claim 15, wherein the location of the second slot is after and closest to the first slot plus a time gap.

18. The method of claim 15, wherein the location of the second slot is a minimum time before the slot indicated by the time resource assignment.

19. The method of claim 15, wherein the location of the second slot based on one of the first slot or the slot indicated by the time resource assignment is configured by a base station or predefined.

20. The method of claim 15, wherein the first UE is a destination of a transmission of the shared channel from the second UE.

21. The method of claim 15, wherein the feedback channel is a physical sidelink feedback channel (PFSCH).

22. The method of claim 15, wherein enablement of reception of the conflict indicator is configured by higher layer signaling.

23. The method of claim 15, the SCI further including one-bit information indicating that the second UE can receive the conflict indicator from the first UE.

24. The method of claim 23, wherein the SCI includes a fewer number of reserved bits when the second UE is configured to transmit the one-bit information.

25. The method of claim 15, wherein the feedback channel includes a first set of resources and a second set of resources, wherein the first set of resources carries acknowledgements (ACKs) or negative ACKs (NACKs) for reception of shared channels, and wherein the second set of resources includes the resources of the feedback channel carrying the conflict indicator.

26. The method of claim 25, wherein the first set of resources and the second set of resources are located on different frequency resources.

27. The method of claim 15, the receiving the conflict indicator comprising:
receiving, by the second UE from the first UE, the conflict indicator in accordance to a priority indicated in the SCI.

28. A first user equipment (UE) comprising:
a non-transitory memory storage comprising instructions; and
one or more processors in communication with the non-transitory memory storage, wherein the instructions, when executed by the one or more processors, cause the first UE to perform operations including:
receiving, from a second UE, a sidelink control information (SCI) in a first slot, the SCI comprising a resource reservation for a shared channel, wherein the resource reservation indicates a set of frequency resources and a time resource assignment; and
transmitting, to the second UE, a conflict indicator on resources of a feedback channel,
wherein the resources of the feedback channel include a second slot for transmitting the conflict indicator, a location of the second slot based on one of the first slot or a slot indicated by the time resource assignment, and
wherein the conflict indicator indicates a potential resource conflict or a detected resource conflict on at least one of the set of frequency resources or the time resource assignment indicated by the resource reservation.

29. A second user equipment (UE) comprising:
a non-transitory memory storage comprising instructions; and
one or more processors in communication with the non-transitory memory storage, wherein the instructions, when executed by the one or more processors, cause the second UE to perform operations including:
transmitting, to a first UE, a sidelink control information (SCI) in a first slot, the SCI comprising a resource reservation for a shared channel, wherein the resource reservation indicates a set of frequency resources and a time resource assignment; and
receiving, from the first UE, a conflict indicator on resources of a feedback channel,
wherein the resources of the feedback channel include a second slot for receiving the conflict indicator, a location of the second slot based on one of the first slot or a slot indicated by the time resource assignment, and
wherein the conflict indicator indicates a potential resource conflict or a detected resource conflict on at least one of the set of frequency resources or the time resource assignment indicated by the resource reservation.
